(19) United States
(12) Patent Application Publication
(10) Pub. No.: US 2009/0286972 A1
(43) Pub. Date: Nov. 19, 2009

(54) CELLULOSE ACYLATE FILM AND METHOD FOR MANUFACTURING THE SAME

(75) Inventor: Tetsuya Yoshida, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 12/095,168

(22) PCT Filed: Nov. 27, 2006
(86) PCT No.: PCT/JP2006/324123

§ 371 Date: May 28, 2008

(30) Foreign Application Priority Data
Nov. 29, 2005 (JP) 2005-344485
Nov. 21, 2006 (JP) 2006-314464

(51) Int. Cl. C08B 3/00; B29C 47/14

(52) U.S. Cl. 536/63; 264/177.1

(57) ABSTRACT

According to the present invention, a film is formed from a powdered cellulose acylate resin using a twin-screw extruder which has complete-mating-type screws and whose L/D is set in the range of 20 to 55, while setting the temperature of the resin in the extruder in the range of Tm+10° C. to Tm+70° C., keeping the average residence time of the cellulose acylate resin within 5 minutes, and drawing a vacuum so that the degree of vacuum in extruder after the powdered cellulose acylate resin has been melted is kept at 100 Torr or lower, whereby the color change or deterioration in mechanical strength of the resin can be decreased, and thus, a high-quality and high-functionality film which is good for the optical application can be provided.

### TECHNICAL FIELD

The present invention relates to a cellulose acylate film and a method for manufacturing, and more specifically, to a cellulose acylate film used for liquid crystal displays and a method for manufacturing the same.

### BACKGROUND ART

A cellulose acylate film is obtained by melting cellulose acylate resin in an extruder, discharging the molten resin from a die to take the form of a sheet, cooling the resin in the form of sheet on a cooling drum, and stripping the cooled resin from the cooling drum (e.g. see Japanese Application Patent Laid-Open No. 2000-352620). And attempts have been made to realize a wider viewing angle in liquid crystal displays by: stretching the cellulose acylate film thus formed longitudinally (across the length) and transversely (across the width) to allow the film to develop in-plane retardation (Re) and thickness-direction retardation (Rth); and using the stretched cellulose acylate film as a retardation film for liquid crystal display devices.

Generally, in the manufacturing a cellulose acylate film, powdered raw material resin is pelletized in a pelletizing extruder and the pelletized cellulose acylate resin is melted in another extruder.

### DISCLOSURE OF THE INVENTION

### Problems to be Solved by the Invention

However, a cellulose acylate film manufactured by the manufacturing method as above presents the problems of being susceptible to change in color by heat (yellowed), because cellulose acylate resin is susceptible to resin deterioration by heating and it undergoes heating by extruder twice: at the time of pelletizing and at the time of melting pellets, and of its mechanical strength's falling, because its molecular weight is decreased by oxidative destruction. These problems contribute to serious defects in optical films, and therefore, it is very important in manufacturing of a cellulose acylate resin film to decrease the heat history as much as possible.

The present invention has been made in the light of these circumstances. Accordingly, an object of the present invention is to provide a high-quality cellulose acylate film in which change in color and deterioration in mechanical strength have been decreased and a method for manufacturing the same.

### Means for Solving the Problems

To achieve the object, a first aspect of the present invention provides a method for manufacturing a cellulose acylate film using a powdered cellulose acylate resin as a resin to be melted in the extruder, the method comprising: melting the cellulose acylate resin fed from a hopper in an extruder; discharging the molten resin from the extruder to feed the same into a die; extruding the molten resin from the die in the form of sheet; and cooling and solidifying the molten resin in the form of sheet, wherein a twin-screw extruder which has complete-mating-type screws and whose L/D is set in the range of 20 to 55 is used while setting the melting temperature for melting the resin to be melted in the range of Tm+10° C. to Tm+70° C., where Tm represents the melting point of the cellulose acylate resin, keeping the average residence time of the cellulose acylate resin, the time from feeding the resin into the extruder to discharging the same from the extruder, within 5 minutes, and drawing a vacuum on the inside of the extruder so that the degree of vacuum in the extruder after the powdered cellulose acylate resin has been melted is kept at 100 Torr or lower.

The term “powdered cellulose acylate resin” herein used means not only completely powdered cellulose acylate resin, but also particulate cellulose acylate resin (resin not pelletized).

The inventor of the present invention has found that in method for manufacturing a cellulose acylate film that include the steps of: melting and pelletizing a powdered cellulose acylate resin, which is synthesized using pulp as a raw material, in a pelletizing extruder and again melting the pellets in another extruder, the melting operation repeated two times may cause heat deterioration or melting non-uniformity in the resin, which results in change in color or deterioration in mechanical strength in the manufactured film. The present inventors have found a method for manufacturing a film excellently even without a step of pelletizing a powdered resin.

According to the first aspect of the present invention, a powdered cellulose acylate can be suitably melted, because a twin-screw extruder which having complete-mating-type rotary screws and whose L/D is in the range of 20 to 55 is used while setting the temperature of the cellulose acylate resin in the extruder in the range of Tm+10° C. to Tm+70° C., keeping the average residence time of the cellulose acylate resin in the extruder within 5 minutes, and drawing a vacuum on the inside of the extruder so that the degree of vacuum in the extruder after the powdered cellulose acylate has been melted is 100 Torr or lower.

Specifically, even when the cellulose acylate resin to be melted is a powdered cellulose acylate resin, use of a twin-screw extruder which has complete-mating-type screws and whose L/D is in the range of 20 to 55 makes it possible to melt the cellulose acylate resin while avoiding the clogging of the extruder by the powdered resin. The reason the L/D is set in the range of 20 to 55 is that if it is as low as less than 20, melting or kneading become insufficient, which causes fine crystals to be more likely to remain, whereas if it is as large as higher than 55, the detention time of the cellulose acylate resin in the extruder becomes too long, which causes the resin to deteriorate, whereby the mechanical strength of the resultant film is more likely to be decreased. The L/D herein used means the ratio of the cylinder length (L) to the cylinder inside diameter (D).

Further, setting the temperature of the cellulose acylate resin in the extruder in the range of the melting point of the resin +10° C. to the melting point of the resin +70° C., keeping the average residence time of the resin in the extruder within 5 minutes, and drawing a vacuum so that the degree of vacuum in the extruder after the powdered cellulose acylate resin has been melted is 100 Torr or lower makes it possible to prevent the resin from being oxidized in the extruder, whereby the change in color or the deterioration in mechanical strength of the resin can be decreased. Particularly in a powdered resin raw material, drawing a vacuum is effective, because it has air trapped in it, thereby being likely to deteriorate by thermal oxidation. But on the other hand, if a vacuum is drawn when the resin is in the form of a powder, the resin in the form of a powder is also drawn by vacuum pump, which may lead to trouble. Thus, it is preferable to draw a vacuum right after the powdered cellulose acylate resin has been melted.

As described above, according to the first aspect of the present invention, the change in color or deterioration in mechanical strength of the resultant film can be decreased, whereby a high-quality cellulose acylate film can be manufactured. Further, a step of pelletizing the powdered cellulose acylate resin can be eliminated, whereby the step is economical.

A second aspect of the present invention is the method for manufacturing a cellulose acylate film according to the first aspect, characterized in that the powdered cellulose acylate resin is melted in the extruder after its moisture content is adjusted to 5000 ppm or lower.

According to the second aspect, the powdered cellulose acylate resin, which has moisture adsorbed on its surface, is melted in the extruder after its moisture content is adjusted to 5000 ppm or lower, whereby the cellulose acylate resin is prevented from reacting with the moisture, and hence undergoing hydrolysis. Thus, the change in color or deterioration in mechanical strength of the resin can be decreased, whereby a high-quality cellulose acylate film can be manufactured.

A third aspect of the present invention is the method for manufacturing a cellulose acylate film according to the first or second aspect of the invention, characterized in that the oxygen concentration in the hopper is 10% or lower.

According to the third aspect, the oxygen concentration in the hopper is kept 10% or lower, whereby the powdered resin is fed into the extruder with a decreased amount of oxygen trapped in it. This in turn makes it possible to prevent the resin from being oxidized in the extruder, and hence decrease the change in color or deterioration in mechanical strength of the resultant film. One possible way to keep the oxygen concentration 10% or lower is to fill the hopper with an inert gas.

A fourth aspect of the present invention is the method for manufacturing a cellulose acylate film according to any one of the first to third aspects, characterized in that the number of revolution of the screws of the extruder is set in the range of 50 to 300 rpm.

According to the fourth aspect, the number of revolution of the screws of the extruder is set in the range of 50 to 300 rpm, whereby the color change of the resin can be prevented which is caused when the number of revolution is too small and the resin is exposed to too much heat, or the breakage of the molecules of the resin can be prevented which is caused when the number of revolution is too large and the resin suffers from too great shearing stress.

A fifth aspect of the present invention is the method for manufacturing a cellulose acylate film according to any one of the first to fourth aspects, characterized in that the cellulose acylate resin is mixed before melting with a heat stabilizer and then fed into the extruder.

According to the fifth aspect, the cellulose acylate resin is mixed with a heat stabilizer before it is melted, whereby a uniform molten resin is provided in which the concentration of the heat stabilizer is even, and besides, thermal deterioration of the resin can be effectively prevented. This makes it possible to manufacture a cellulose acylate film in which optical properties are uniform.

A sixth aspect of the present invention is the method for manufacturing a cellulose acylate film according to any one of the first to fifth aspects, characterized in that the powdered cellulose acylate resin is fed into the extruder by a constant-weight feeder.

According to the sixth aspect, the powdered cellulose acylate resin is fed by a constant-weight feeder, whereby the amount of the resin fed into the extruder can be kept constant, allowing the melting of the resin to be uniform. Thus, manufacturing a film in which optical properties are not uniform can be prevented.

A seventh aspect of the present invention is a cellulose acylate film, characterized in that it is manufactured by the manufacturing method according to any of the first to sixth aspects.

The cellulose acylate film manufactured in accordance with the present invention is suitable for an optical film used in liquid crystal displays.

### ADVANTAGES OF THE INVENTION

According to the present invention, a film is formed from a powdered cellulose acylate resin using a twin-screw extruder which has complete-mating-type screws and whose L/D is set in the range of 20 to 55, while setting the temperature of the resin in the extruder in the range of Tm+10° C. to Tm+70° C., keeping the average residence time of the cellulose acylate resin within 5 minutes, and drawing a vacuum so that the degree of vacuum in extruder after the powdered cellulose acylate resin has been melted is kept at 100 Torr or lower, whereby the color change or deterioration in mechanical strength of the resin can be decreased, and thus, a high-quality and high-functionality film which is good for the optical application can be provided.

### BRIEF DESCRIPTION OF THE DRAWINGS

FIG. 1 is a block diagram showing the film manufacturing apparatus to which the present invention is applied;

FIG. 2 is a schematic view showing the construction of the twin-screw extruder used in the present invention;

FIG. 3 is a table showing examples of the present invention; and

FIG. 4 is another table showing examples of the present invention.

### DESCRIPTION OF SYMBOLS

10 . . . Film manufacturing apparatus
11 . . . Vacuum pump
12 . . . Cellulose acylate film
14 . . . Film forming section
16 . . . Longitudinal stretching section
18 . . . Transverse stretching section
20 . . . Winding-up section
22 . . . Twin-screw extruder
22a . . . Motor
23 . . . Constant weight feeding machine (feeder)
23a . . . Hopper
24 . . . Die
25 . . . Dehumidifying air drier
26 . . . Cooling drum
27 . . . Mixer
29 . . . Nitrogen producing machine
31 . . . Nip rolls
32 . . . Cylinder
34 . . . Screw shaft
36 . . . Screw flight
38 . . . Screw
40 . . . Feed opening
42 . . . Discharge opening
44 . . . Gear pump
46 . . . Filter unit
D . . . Inside diameter of cylinder
L . . . Length of cylinder

### BEST MODE FOR CARRYING OUT THE INVENTION

In the following preferred embodiments of the method for manufacturing a cellulose acylate film of the present invention will be described with reference to the accompanying drawings.

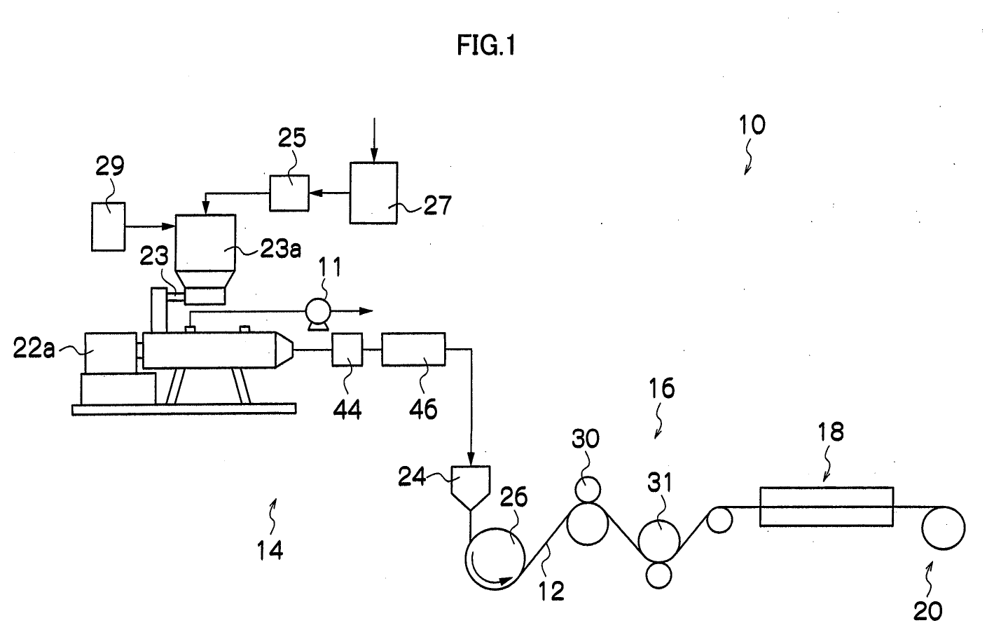

FIG. 1 is a schematic diagram showing one example of apparatus for manufacturing a cellulose acylate film. As shown in FIG. 1, a manufacturing apparatus 10 consists mainly of: a film forming section 14 where an unstretched cellulose acylate film 12 is formed; and a winding-up section 20 where the cellulose acylate film 12 is wound up. The apparatus may include: a longitudinal stretching section 16 where the cellulose acylate film 12 formed in the film forming section 14 is stretched longitudinally; and a transverse stretching section 18 where the cellulose acylate film 12 is stretched transversely.

In the film forming section 14, the cellulose acylate resin having been melted in an extruder 22 is discharged from a die 24 so that it takes the form of a sheet and cast upon a rotating cooling drum 26, where the molten resin in the form of sheet is cooled and solidified to yield the cellulose acylate film 12. The cellulose acylate film 12 is then stripped from the cooling drum 26 and wound up into a roll in the winding-up section 20. The cellulose acylate film 12 may be fed to the longitudinal stretching section 16 and the transverse stretching section 18 in this order to be stretched, if necessary. Each of the above sections will be described in detail below.

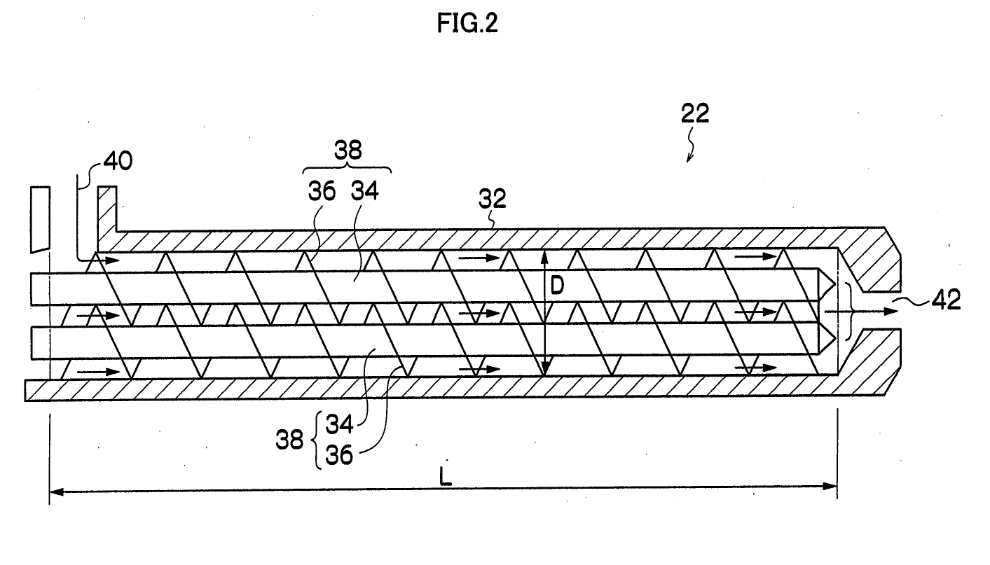

FIG. 2 shows the construction of the extruder 22 in the film forming section 16. As shown in FIG. 2, the extruder 22 is a twin-screw extruder that includes in a cylinder 32 two screws 38, 38 each of which is made up of a screw shaft 34 and a screw flight 38 attached to the screw shaft 34, a screw flight 36 of each screw 38 is of complete mating type. Each screw 38 is rotationally driven by a motor 22a (see FIG. 1). As the extruder 22, an extruder in which two screw shafts 34, 34 are arranged parallel with each other or slanted relative to each other may be used. Further, an extruder in which two screw shafts 34, 34 are rotated in the same direction or in the respective different directions may be used. The extruder 22, which has a construction as above, has an improved extrusion performance, compared with a single-screw extruder or a twin-screw extruder of non-mating type. And the extruder 22 enables melting a resin, even a powdered resin, uniformly while avoiding the resin's sticking to the screw shaft 34 or the screw flight 36 or avoiding the resin's not coming in contact with the screw 38 and insufficient melting. Thus, use of a complete-mating-type twin-screw extruder makes it possible to directly melt a powdered cellulose acylate resin, as a raw material, in the extruder 22 and extrude toward the die 24 without the pelletizing operation, whereby the change in color of the resin by heat can be prevented, and besides, the film manufacturing method can be economical due to the elimination of the pelletizing step.

On the outer periphery of the cylinder 32 is mounted a jacket, not shown in the figures, through which the inside of the cylinder can be controlled to a desired temperature. The temperature is controlled so that the temperature of the resin should not be higher than 240° C. due to the heat generated by shearing.

On a feed opening 40 of the cylinder 32 is provided a hopper 23a via a screw-type constant-weight feeder 23 (feeder). A powdered cellulose acylate resin is fed from the hopper 23a into the cylinder 32 through the constant-weight feeder 23. Feeding a powdered cellulose acylate resin through the constant-weight feeder 23 allows the amount of resin fed into the extruder 22 to be kept constant, whereby the resin can be melted uniformly.

Preferably the oxygen concentration in the hopper is 10% or lower. Allowing the oxygen concentration in the hopper to be 10% or lower makes it possible to feed a powdered cellulose acylate resin into the extruder 22 with a decreased amount of oxygen trapped in it. This in turn makes it possible to prevent the resin from being oxidized in the extruder 22. One possible way to keep the oxygen concentration in the hopper 10% or lower is to fill the hopper with an inert gas using, for example, a nitrogen generating apparatus 29 shown in FIG. 1.

Preferably a cellulose acylate resin is used which has a molecular weight of 20000 to 80000, preferably 30000 to 70000, and more preferably 35000 to 60000. If the molecular weight is smaller than the above range, the mechanical strength of resultant the cellulose acylate film 12 becomes low. Conversely, if the molecular weight is larger than the above range, the viscosity of the molten resin becomes large, which requires the processing temperature to be set high. Thus, the processing temperature becomes close to the thermal decomposition temperature, which may cause change in color due to the heat deterioration of the resin, generation of contaminants, and poor appearance in resultant the cellulose acylate film 12. Accordingly, use of a cellulose acylate resin having a molecular weight in the above range can provide resultant the cellulose acylate film 12 with sufficient mechanical strength and improved appearance.

Preferably the powdered cellulose acylate resin to be used is dried, since it is likely to absorb moisture. Drying is often performed using a dehumidifying air drier 25, but the drying method is not limited to this. Any one of heating, air blast, pressure reduction or stirring alone or two or more of them in combination may be used, as long as drying can be performed efficiently and an intended moisture content is obtained.

Preferably the drying temperature is in the range of 0 to 200° C., more preferably 40 to 180° C., and particularly preferably 60 to 150° C. Too low a drying temperature is not preferable, because it requires a longer time for drying, and moreover, the water content cannot be decreased to a target value or lower. Conversely, too high a drying temperature is also not preferable, because the resin becomes sticky and blocking is caused in it. Preferably the air flow for drying is 20 to 400 m³/hour, more preferably 50 to 300 m³/hour, and particularly preferably 100 to 250 m³/hour. Too low an air flow is not preferable, because it makes drying efficiency low. However, increasing an air flow to higher than 400 m³/hour is not economical, because improvement in drying effect cannot be expected any more. Preferably the dew point of air is 0 to −60° C., more preferably −10 to −50° C., and particularly preferably −20 to −40° C. The drying time is required to be at least 15 minutes or longer. Preferably it is 1 hour or longer and particularly preferably 2 hours or longer. However, if drying is performed for longer than 50 hours, further moisture-content reducing effect cannot be expected. On the contrary, the possibility of heat deterioration of the resin is produced. Thus, increasing the drying time unnecessarily is not preferable. The moisture content of the powdered cellulose acylate resin is preferably 5000 ppm or lower.

Adjusting the moisture content of the powdered cellulose acylate resin in the above range can prevent the cellulose acylate resin from reacting with the moisture, and hence undergoing hydrolysis when it is melted in the extruder 22. Thus, the change in color or deterioration in mechanical strength of the resin can be decreased, whereby a high-quality cellulose acylate film can be manufactured.

The cellulose acylate resin is mixed with heat stabilizer depending on the situation. As the heat stabilizer, preferably either one of or both of phosphite compound and phosphite ester compound are used. The amount of the heat stabilizer mixed is preferably 0.005 to 0.5% by weight, more preferably 0.01 to 0.4% by weight, and much more preferably 0.02 to 0.3% by weight.

Preferably the cellulose acylate resin is mixed with a heat stabilizer in a mixer 27 before it is fed into the extruder 22. Mixing the cellulose acylate resin before melted with a heat stabilizer makes it possible to provide a uniform molten resin. Specifically, the concentration of the heat stabilizer in the molten resin is allowed to be even by mixing the cellulose acylate resin with a heat stabilizer before it is melted, whereby thermal deterioration of the resin can be effectively prevented and a cellulose acylate film having uniform optical properties can be provided.

The cellulose acylate resin described above is fed into the cylinder 32 through the feed opening 40 of the extruder 22.

The L/D of the screws of the extruder 22 is set in the range of 20 to 55. The L/D herein used means the ratio of the cylinder length (L) to the cylinder inside diameter (D) of FIG. 2.

The L/D lower than 20 causes insufficient melting or insufficient kneading, which makes fine crystals more likely to remain in the resultant cellulose acylate film 12. Conversely, the L/D higher than 55 makes too long a detention time of the cellulose acylate resin in the extruder 22, which makes the resin more likely to deteriorate. Too long a detention time may cause molecule breakage, which results in decrease in molecular weight, and hence the deterioration in mechanical strength of the film.

Preferably the number of revolution of the screws 38, 38 of the extruder 22 is set in the range of 50 to 300 rpm. Setting the number of revolution in the above range makes it possible to prevent the color change of the resin which is caused when the number of revolution is too small and the resin is exposed to too much heat or prevent the breakage of the molecules which is caused when, the number of revolution is too large and the resin suffers from too great shearing stress.

Further, a vacuum is drawn on the inside of the cylinder 32 of the extruder 22 with vacuum pump 11 after the powdered cellulose acylate resin has been melted so that the vacuum degree is 100 Torr or lower in the cylinder. Drawing a vacuum on the inside of the cylinder 32 after the powdered cellulose acylate resin has been melted so that the vacuum degree is 100 Torr or lower in the cylinder makes it possible to prevent the resin from being oxidized in the extruder, thereby decreasing the change in color or deterioration in mechanical strength of the resin. A powdered cellulose acylate resin, as in the case of the present invention, has air trapped in it, and therefore, drawing a vacuum is effective. The reasons that a vacuum is drawn, after the powdered cellulose acylate resin has been melted, midway along the extruder are: that before the resin is melted, there exists no seal between the opening for the addition of the resin and the opening for the drawing of a vacuum, whereby a sufficient vacuum degree cannot be achieved; and that if a vacuum is drawn when the resin is in the form of a powder, powdered resin is also drawn by the vacuum pump, which leads to trouble.

If the temperature of the resin in the extruder 22 is as low as lower than Tm+10° C., the crystals do not melt sufficiently, whereby fine crystals are made more likely to remain in the cellulose acylate film 12. The residual fine crystals interfere with the film stretchability, and when the cellulose acylate film 12 is stretched, it cannot be sufficiently oriented. Conversely, if the temperature of the resin in the extruder 22 is as high as higher than Tm+70° C., the cellulose acylate resin deteriorates, yellowness (YI value) is made worsen.

The cellulose acylate film 12 formed with the extruder 22, where extruding conditions are set as above, has characteristics: a haze of 2.0% or lower; and a yellow index (YI value) of 10 or smaller.

The haze is used as an index of whether the extrusion temperature is too low or not, in other words, an index of the amount of the crystals remaining in the resultant cellulose acylate film. If the haze is higher than 2.0%, the amount of fine crystals remaining in resultant cellulose acylate film 12 is large, whereby cellulose acylate film 12 is more likely to drawing break. The yellow index (YI value) is used as an index of whether the extrusion temperature is too high or not, and if the yellow index (YI value) is 10 or 13 ww, there is no problem with yellowness.

The cellulose acylate resin is melted in the extruder 22 constructed as above, and the molten resin is continuously fed from discharge opening 42 into the die 24 via a gear pump 44 and a filter unit 46 (see FIG. 1). In this feeding operation, the average residence time of the resin in the cylinder is set within 5 minutes. If the average residence time of the resin is longer than 5 minutes, the resin may suffer from heat deterioration in the cylinder 32, thereby producing gel or contaminants, which may cause contaminant-related faults. Thus, setting the average residence time of the resin within 5 minutes makes it possible to prevent the production of gel or contaminants, and hence the occurrence of contaminant-related faults in resultant the cellulose acylate film 12. This in turn makes it possible to produce high-quality the cellulose acylate film 12 suitably used as an optical film. The average residence time of the resin in the cylinder 32 is preferably within 5 minutes, more preferably within 3 minutes, and much more preferably within 2 minutes. Meanwhile, from the viewpoint of obtaining the effect of sufficiently kneading the resin, the average residence time of the resin is preferably 20 seconds or longer, more preferably 30 seconds or longer, and much more preferably 40 seconds or longer.

The molten resin fed into the die 24 by the extruder 22 is extruded from the die 24 so that it takes the form of a sheet and cast upon the cooling drum 26 where it is cooled and solidified to yield the cellulose acylate film 12. To prevent heat deterioration or color development, the temperature of the molten polymer at the time when the polymer is extruded form the die 24 is preferably Tg+70° C. or higher and Tg+120° C. or lower. Preferably the lip clearance ratio D/W, where D represents the lip clearance of the die 24 and W represents the thickness of the molten resin discharged from the die 24, is controlled so that it falls in the range of 1.5 to 10. Preferably the die 24 is so formed that its slit and the vertical line form an angle in the range of 0 to 45° in the direction in which the cooling drum 26 is rotated.

As described so far, in the film forming section 14, the cellulose acylate film 12 is formed in such a manner that it is less likely to undergo change in color or deterioration in mechanical strength, whereby a high-quality cellulose acylate film can be manufactured. Further, in the film forming section 14, a powdered cellulose acylate resin can be directly melted in extruder, whereby the step of pelletizing the powdered cellulose acylate resin can be eliminated and a cellulose acylate film can be manufactured economically.

The cellulose acylate film 12 formed in the film forming section 14 is stretched in the longitudinal stretching section 16 and in the transverse stretching section 18.

In the following the stretching step, where the cellulose acylate film 12 formed in the film forming section 14 is stretched to manufacture stretched the cellulose acylate film 12.

When the cellulose acylate film 12 is drawn, the molecules of the cellulose acylate film 12 are orientationally ordered to express in-plane retardation (Re) and thickness-direction retardation (Rth). The retardation Re and Rth can be obtained by the following equations.

Re(nm)=|n(MD)−n(TD)|×T(nm)

Rth(nm)=|{(n(MD)+n(TD))/2}−n(TH)|×T(nm).

where n(MD), n(TD), and n(TH) denote the refractive indexes in the longitudinal direction, width direction and thickness direction, respectively, and T (nm) denotes the thickness of a film.

A cellulose acylate film 12 is first drawn in the longitudinal direction in a longitudinal drawing unit 16 as shown in FIG. 1. In the longitudinal drawing unit 16, the cellulose acylate film 12 is preheated and the cellulose acylate film 12 thus heated is rolled over two nip rolls 28,30. Since the nip roll 30 near the outlet rotates at a higher speed than the nip roll 28 near the inlet, the cellulose acylate film 12 is drawn in the longitudinal direction.

The preheating temperature in the longitudinal stretching section 16 is preferably Tg−40° C. or higher and Tg+60° C. or lower, more preferably Tg−20° C. or higher and Tg+40° C. or lower, and much more preferably Tg or higher and Tg+30° C. or lower. The stretching temperature in the longitudinal stretching section 16 is preferably Tg or higher and Tg+60° C. or lower, more preferably Tg+2° C. or higher and Tg+40° C. or lower, and much more preferably Tg+5° C. or higher and Tg+30° C. or lower. The draw ratio in the longitudinal stretching is preferably 1.0 or higher and 2.5 or lower and more preferably 1.1 or higher and 2 or lower.

The cellulose acylate film 12 longitudinally drawn is fed to a transverse drawing unit 18 in which it is drawn in the width direction. In the transverse drawing unit 18, a tenter, for example, is preferably used. The cellulose acylate film 12 is drawn transversely by the tenter while holding both edges (in the width direction) of the cellulose acylate film by clips. The transverse drawing further increases retardation Rth.

Preferably the transverse stretching is performed using a tenter. The preferable stretching temperature is Tg or higher and Tg+60° C. or lower, more preferably Tg+2° C. or higher and Tg+40° C. or lower, and much more preferably Tg+4° C. or higher and Tg+30° C. or lower. The draw ratio in the transverse stretching is preferably 1.0 or higher and 2.5 or lower and more preferably 1.1 or higher and 2 or lower. After the transverse stretching, preferably stretched acylate film undergoes either one of or both of longitudinal relaxation and transverse relaxation. Such relaxation makes it possible to decrease the distribution of the slow axis across the width.

By virtue of such drawing, drawn cellulose acylate film having retardation Re and Rth expressed therein can be obtained. A drawn cellulose acylate film preferably has Re from 0 nm to 500 nm (both inclusive), more preferably 10 nm to 400 nm (both inclusive), further preferably 15 nm to 300 nm (both inclusive), and has Rth from 0 nm to 500 nm (both inclusive), more preferably 50 nm to 400 nm (both inclusive), further preferably 70 nm to 350 nm (both inclusive).

Of them, a drawn cellulose acylate film having Re and Rth which satisfies the relationship Re≦Rth is more preferable and satisfies the relationship Re×2≦Rth is further preferable. To attain high Rth and low Re, the cellulose acylate film is preferably first drawn longitudinally and then drawn transversely (in the width direction). The difference in orientation between the longitudinal direction and the transverse direction becomes the difference of retardation (Re). However, the difference of retardation, that is, in-plane retardation (Re), can be reduced by drawing not only in the longitudinal direction but also in the perpendicular direction, that is, the transverse direction, thereby reducing difference in the longitudinal orientation and the transverse orientation. On the other hand, drawing is performed not only in the longitudinal direction but also in the transverse direction, the area is enlarged and the thickness decreases. As the thickness decreases, the orientation of thickness direction increases, increasing Rth.

Furthermore, positional variations in Re and Rth in the width direction and the longitudinal direction are preferably 5% or less, more preferably 4% or less, and further preferably 3% or less.

The cellulose acylate film 12 having been stretched is wound up into a roll in the winding-up section 20 of FIG. 1. The winding-up tension applied to the cellulose acylate film 12 is preferably 0.02 kg/mm² or lower. Setting the winding-up tension in such a range makes it possible to wind up stretched the cellulose acylate film 12 without causing retardation distribution in the film.

Now, a method of synthesizing cellulose acylate resin suitable for the present invention, a method of synthesizing a cellulose acylate film 12 before drawing, and a method for processing a cellulose acylate film 12 will be explained in accordance with procedures.

(1) Plasticizer

It is preferable to add polyvalent alcohol based plasticizer to a resin for producing a cellulose acylate film according to the present invention. Such a plasticizer is effective in reducing not only elastic modulus and difference in crystal amount of upper and lower surfaces.

The content of polyvalent alcohol based plasticizer is preferably 2 to 20% by weight relative to cellulose acylate. The content of polyvalent alcohol based plasticizer is preferably 2 to 20% by weight, more preferably 3 to 18% by weight, and further preferably 4 to 15% by weight.

When the content of a polyvalent alcohol based plasticizer is less than 2% by weight, the aforementioned effects cannot be sufficiently obtained. On the other hand, when the content of a polyvalent alcohol based plasticizer is more than 20% by weight, occurs bleeding (plasticizer precipitates) on the surface of the film.

The polyvalent alcohol based plasticizer to be used in the present invention preferably has good compatibility with cellulose fatty acid ester and significantly exhibits thermo-plasticity. Examples of such a polyvalent alcohol based plasticizer include a glycerin based ester compounds such as glycerin ester and diglycerin ester, a polyalkylene glycol such as polyethylene glycol and polypropylene glycol, and a compound of polyalkylene glycol whose hydroxy group having an acyl group added thereto.

Specific examples of the glycerin ester include glycerin diacetate stearate, glycerin diacetate palmitate, glycerin diacetate myristate, glycerin diacetate laurate, glycerin diacetate caprate, glycerin diacetate nonanate, glycerin diacetate octanoate, glycerin diacetate heptanoate, glycerin diacetate hexanoate, glycerin diacetate pentanoate, glycerin diacetate oleate, glycerin acetate dicaprate, glycerin acetate dinonanate, glycerin acetate dioctanoate, glycerin acetate diheptanoate, glycerin acetate dicaproate, glycerin acetate divalerate, glycerin acetate dibutyrate, glycerin dipropionate caprate, glycerin dipropionate laurate, glycerin dipropionate myristate, glycerin dipropionate palmitate, glycerin dipropionate stearate, glycerin dipropionate oleate, glycerin tributyrate, glycerin tripentanoate, glycerin monopalmitate, glycerin monostearate, glycerine distearate, glycerin propionate laurate and glycerin oleate propionate. However, these are not limitative and may be used either alone or in combination thereof.

Among these, glycerin diacetate caprylate, glycerin diacetate pelargonate, glycerin diacetate caprate, glycerin diacetate laurate, glycerin diacetate myristate, glycerin diacetate palmitate, glycerin diacetate stearate and glycerin diacetate oleate are preferred.

Specific examples of the diglycerin esters include mixed acid esters of diglycerin such as diglycerin tetraacetate, diglycerin tetrapropionate, diglycerin tetrabutyrate, diglycerin tetravalerate, diglycerin tetrahexanoate, diglycerin tetraheptanoate, diglycerin tetracaprylate, diglycerin tetrapelargonate, diglycerin tetracaprate, diglycerin tetralaurate, diglycerin tetramyristate, diglycerin tetrapalmitate, diglycerintriacetate propionate, diglycerin triacetate butyrate, diglycerin triacetate valerate, diglycerin triacetate hexanoate, diglycerin triacetate heptanoate, diglycerin triacetate caprylate, diglycerin triacetate pelargonate, diglycerin triacetate caprate, diglycerin triacetate laurate, diglycerin triacetate myristate, diglycerin triacetate palmitate, diglycerin triacetate stearate, diglycerin triacetate oleate, diglycerin diacetate dipropionate, diglycerin diacetate dibutyrate, diglycerin diacetate divalerate, diglycerin diacetate dihexanoate, diglycerin diacetate diheptanoate, diglycerin diacetate dicaprylate, diglycerin diacetate dipelargonate, diglycerin diacetate dicaprate, diglycerin diacetate dilaurate, diglycerin diacetate dimyristate, diglycerin diacetate dipalmitate, diglycerin diacetate distearate, diglycerin diacetate dioleate, diglycerin acetate tripropionate, diglycerin acetate tributyrate, diglycerin acetate trivalerate, diglycerin acetate trihexanoate, diglycerin acetate triheptanoate, diglycerin acetate tricaprate, diglycerin acetate tripelargonate, diglycerin acetate tricaprate, diglycerin acetate trilaurate, diglycerin acetate trimyristate, diglycerin acetate tripalmitate, diglycerin acetate tristearate, diglycerin acetate trioleate, diglycerin laurate, diglycerin stearate, diglycerin caprylate, diglycerin myristate and diglycerin oleate. However, these are not limitative, and may be used either alone or in combination thereof.

Among these, diglycerin tetraacetate, diglycerin tetrapropionate, diglycerin tetrabutyrate, diglycerin tetracaprylate and diglycerin tetralaurate are preferred.

Specific examples of the polyalkylene glycols include polyethylene glycol and polypropylene glycol having a weight average molecular weight of from 200 to 1,000. However, there are not limitative, and may be used either alone or in combination thereof.

Specific examples of the compounds in which an acyl group is bound to the hydroxyl group of polyalkylene glycol include polyoxyethylene acetate, polyoxyethylene propionate, polyoxyethylene butyrate, polyoxyethylene valerate, polyoxyethylene caproate, polyoxyethylene heptanoate, polyoxyethylene octanoate, polyoxyethylene nonanate, polyoxyethylene caprate, polyoxyethylene laurate, polyoxyethylene myristate, polyoxyethylene palmitate, polyoxyethylene stearate, polyoxyethylene oleate, polyoxyethylene linoleate, polyoxypropylene acetate, polyoxypropylene propionate, polyoxypropylene butyrate, polyoxypropylene valerate, polyoxypropylene caproate, polyoxypropylene heptanoate, polyoxypropylene octanoate, polyoxypropylene nonanate, polyoxypropylene caprate, polyoxypropylene laurate, polyoxypropylene myristate, polyoxypropylene palmitate, polyoxypropylene stearate, polyoxypropylene oleate and polyoxypropylene linoleate. However, these are not limitative, and may be used either alone or in combination thereof.

Furthermore, to sufficiently exhibit the effect of these polyvalent alcohols, it is preferable to form a cellulose acylate film from a molten material under the conditions mentioned below. More specifically, the cellulose acylate film is formed by mixing cellulose acylate and a polyhydric alcohol to form pellets, melting the pellets in an extruder and extruding from a T die. Preferably, the outlet temperature (T2) of the extruder is higher than the inlet temperature (T1). Further preferably the temperature (T3) of the die is higher than the T2. In short, it is preferable that as melting proceeds, the temperature of the product line increases. This is because, if the temperature of a raw material fed from the inlet is raised sharply, the polyhydric alcohol is first liquefied to become a liquid, with the result that cellulose acylate floats in the liquefied polyhydric alcohol. To the raw material in such a state, sheering force from a screw cannot be sufficiently applied. As a result, a non-molten product is produced. When the raw material not well mixed as mentioned, the effect of a plasticizer as mentioned above cannot be produced and the effect of suppressing the difference between the upper surface and the lower surface of a melt-film after extrusion of the molten film cannot be obtained. Furthermore, a non-molten product turns into a foreign matter like a fish eye after film formation. Such a foreign matter does not look bright under observation using a polarizer and is visually observed on a screen by projecting light from the back surface of the resultant film. The fish eye causes tailing at the outlet of the die and increasing the number of die lines.

T1 is preferably 150° C. to 200° C., more preferably 160° C. to 195° C., and further preferably 165° C. to 190° C. (both inclusive). T2 is preferably 190° C. to 240° C., more preferably 200° C. to 230° C., and further preferably 200° C. to 225° C. It is important that such melting temperatures T1, T2 of an extruder are 240° C. or less. If the temperatures T1, T2 exceed 240° C., the elastic modulus of the resultant film is apt to increase. This is considered because melting takes place at high temperature, cellulose acylate is decomposed, which causes crosslinking and increases elastic modulus. The die temperature T3 is preferably 200° C. to less than 235° C., more preferably 205° C. to 230° C. and further preferably 205° C. to 225° C. (both inclusive).

(2) Stabilizer

In the present invention, as a stabilizer, either one or both of a phosphite based compound and a phosphite ester based compound are preferably used. By the presence of the stabilizer, deterioration with time can be suppressed and die lines can be improved. This is because these compounds stabilizer acts as a leveling agent to cancel die lines formed by the concave-convex portions of the die.

The content of the stabilizer is preferably 0.005% by weight to 0.5% by weight, more preferably 0.01% by weight to 0.4% by weight, and further preferably 0.02% by weight to 0.3% by weight.

(i) Phosphite Based Stabilizer

A phosphite based coloring inhibitor is not particularly limited; however, phosphite based coloring inhibitors represented by chemical formulas (general formulas) (1) to (3) are preferable.

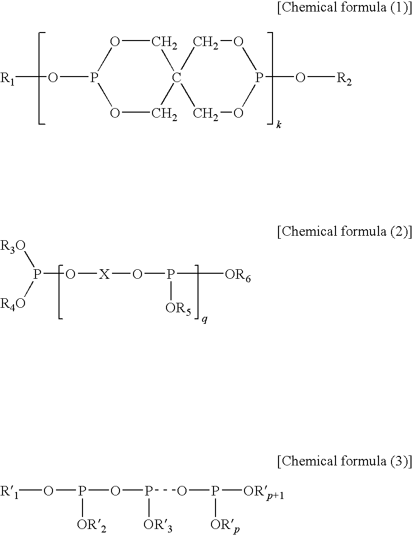

where R1, R2, R3, R4, R5, R6, R′1, R′2, R′3 . . . R′n, R′n+1 each is a group selected from the group consisting of a hydrogen atom, alkyl, aryl, alkoxyalkyl, aryloxyalkyl, alkoxyaryl, arylalkyl, alkylaryl, polyaryloxyalkyl, polyalkoxyalkyl and polyalkoxyaryl groups having 4 to 23 carbon atoms. However, in each of the chemical formulas (general formulas) (1), (2), (3), all of the R1, R2, R3, R4, R5, R6, R′1, R′2, R′3 . . . R′n, R′n+1 are not hydrogen atoms. In the phosphite based coloring inhibitor represented by the general formula (2), X represents a group selected from the group consisting of an aliphatic chain, an aliphatic chain having an aromatic nucleus as a side chain, an aliphatic chain having an aromatic nucleus in the chain, and a chain having oxygen atoms (two or more oxygen atoms are not present next to each other). Furthermore, k and q each are an integer of 1 or more and p is an integer of 3 or more.

The integer k and q of the phosphite based coloring inhibitor are preferably an integer of 1 to 10. This is because when the integer k and q each are 1 or more, the volatility during heating decreases, whereas when the integer k and q each are 10 or less, the compatibility of the phosphite based coloring inhibitor with cellulose acetate propionate is improved. Furthermore, the value of p is preferably 3 to 10. This is because, when p is 3 or more, the volatility during heating decreases, whereas when p is 10 or less, the compatibility of the phosphite based coloring inhibitor with cellulose acetate propionate is improved.

As a phosphite based coloring inhibitor represented by the chemical formula (general formula) (4) below, for example, compounds represented by the following chemical formulas (5) to (8) are preferable.

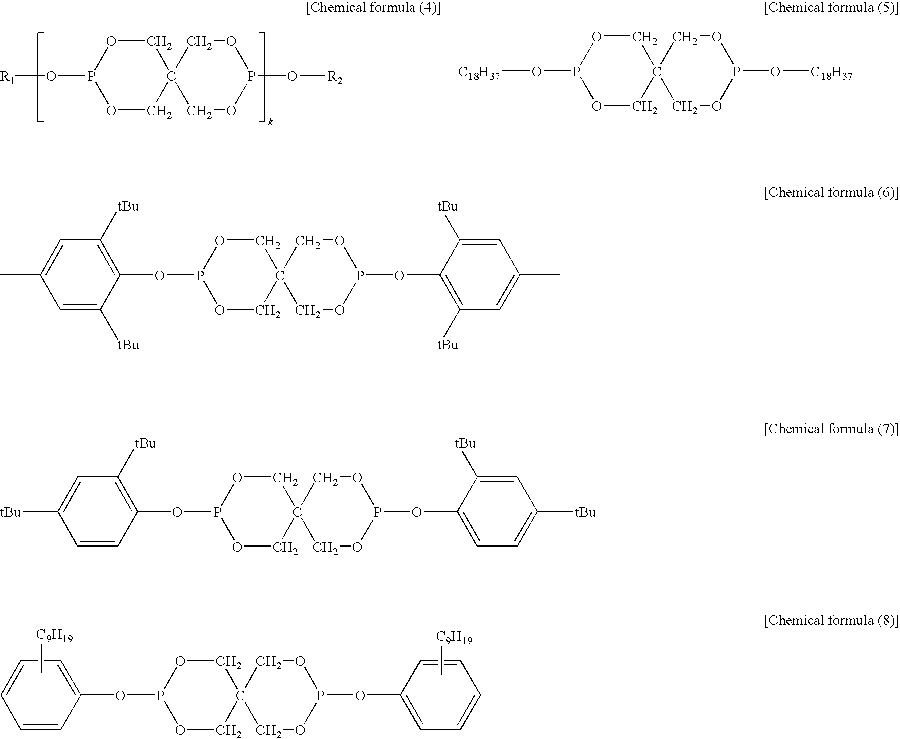

As a phosphite based coloring inhibitor represented by the chemical formula (general formula) (9) below, for example, compounds represented by the following chemical formulas (10) to (12) are preferable.

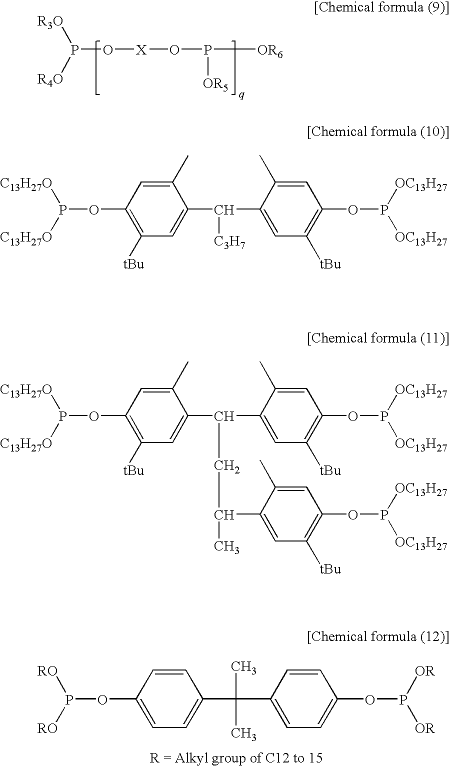

(ii) Phosphite Stabilizer

Examples of the phosphite stabilizer include cyclic neopentanetetraylbis(octadecyl)phosphite, cyclic neopentanetetraylbis(2,4-di-t-butylphenyl)phosphite, cyclic neopentanetetraylbis(2,6-di-t-butyl-4-methylphenyl)phosphite, 2,2-methylenebis(4,6-di-t-butylphenyl)octylphosphite, and tris(2,4-di-butylphenyl)phosphite.

(iii) Other Stabilizer

A weak organic acids, thioether compound, or epoxy compound may be blended as a stabilizer.

The weak organic acid is not particularly limited as long as it has a pKa value of 1 or more, does not prevent the function of the present invention, and prevents coloring and deterioration of physical properties. Examples of such a stabilizer include tartaric acid, citric acid, malic acid, fumaric acid, oxalic acid, succinic acid, and maleic acid. They may be used singly or in a mixture of two or more types.

Examples of the thioether compound include dilaurylthiodipropionate, ditridecylthiodipropionate, dimrystylthiodipropionate, distearylthiodipropionate and palmitylstearylthiodipropionate. They may be used singly or in a mixture of two or more types.

Examples of the epoxy compound include a compound derived from epichlorohydrin and bisphenol A, a derivative of epichlorohydrin and glycerin and a cyclic compound such as vinylcyclohexene dioxide and 3,4-epoxy-6-methylcyclohexylmethyl-3,4 epoxy-6-methylcyclohexane carboxylate. Furthermore, epoxylated soybean oil, epoxylated castor oil, and long-chain α-olefin oxides may be used. They may be used singly or in a mixture of two or more types.

(3) Cellulose Acylate

(Cellulose Acylate Resin)

(Composition/Substitution Degree)

The cellulose acylate (resin) used in the present invention preferably satisfies all requirements represented by Equations (1) to (3).

2.0≦X+Y≦3.0 Equation (1)

0≦X≦2.0 Equation (2)

1.0≦Y≦2.9 Equation (3)

In the Equations (1) to (3), X represents a substitution degree of acetate groups, Y is the sum of substitution degrees of a propionate group, a butyrate group, a pentanoyl group, and a hexanoyl group.

More preferably

2.4≦X+Y≦3.0 Equation (4)

0.05≦X≦1.8 Equation (5)

1.3≦Y≦2.9 Equation (6)

Further preferably

2.5≦X+Y≦2.95 Equation (7)

0.1≦X≦1.6 Equation (8)

1.4≦Y≦2.9 Equation (9)

As described above, it is characterized in that a propionate group, a butyrate group, a pentanoyl group, and a hexanoyl group are introduced into cellulose acylate. When the above range is obtained, a melting temperature is decreased and thermolysis associated with film formation from a molten material can be suppressed and it is preferable. On the other hand, when these values are outside the range, the elastic modulus is outside the range and it is not preferable.

These cellulose acylate compounds may be used singly or in a mixture of two or more types. Polymer components except for cellulose acylate may be appropriately mixed. Next, a method for manufacturing the cellulose acylate according to the present invention will be explained in detail. A raw material, cotton and a synthetic method for cellulose acylate of the present invention are more specifically described in Technical Report No. 2001-1745, published on Mar. 15, 2001 by the Japan Institution of Invention and Innovation, pages 7 to 12).

(Raw Material and Pretreatment)

A cellulose material is preferably derived from a broad-leaved tree, a coniferous tree, and cotton linter. As a cellulose material, a high-purity material containing α-cellulose in a high amount of 92% by weight to 99.9% by weight (both inclusive) is preferable.

When a cellulose material is in the form of film and weight, it is preferable to break it in advance. Cellulose is preferably broken to a fluff state.

(Activation)

Prior to acylation, it is preferable that a cellulose material is brought into contact with the activating agent (activating treatment). As an activator, carboxylic acid or water can be used. When using water as an activator, preferably the steps of: adding excess acid anhydride to dehydrate the cellulose raw material, washing the raw material with carboxylic acid to replace water, and adjusting the acylation conditions are included after the activation. The temperature of the activator may be adjusted arbitrarily before the activator is added to the cellulose raw material. The adding method can be selected from among dropping, dipping, etc.

Preferable examples of a carboxylic acid serving as an activating agent include a carboxylic acid having 2 to 7 carbon atoms such as acetic acid, propionic acid, butyric acid, 2-methylpropionic acid, valeric acid, 3-methylbutyric acid, 2-methylbutyric acid, 2,2-dimethylpropionic acid (pivalic acid), hexanoic acid, 2-methylvaleric acid, 3-methylvaleric acid, 4-methylvaleric acid, 2,2-dimethylbutyric acid, 2,3-dimethylbutyric acid, 3,3-dimethylbutyric acid, cyclopentane carboxylic acid, heptanoic acid, cyclohexane carboxylic acid, and benzoic acid; more preferable examples are acetic acid, propionic acid and butyric acid. Of them, acetic acid is particularly preferable.

In activating, an acylation catalyst such as sulfuric acid may be further added. However, addition of a strong acid such as sulfuric acid may sometimes accelerate the depolymerization, and thus, it is preferable to keep the amount of the strong acid added within the range of 1% by mass to about 10% by mass relative to cellulose. Furthermore, two or more types of activating agents may be added or an anhydride of a carboxylic acid having 2 to 7 carbon atoms may be added.

The addition amount of the activating agent is preferably not less than 5% by weight relative to cellulose, more preferably not less than 10% by weight, and particularly preferably, not less than 30% by weight. If the amount of the activator added is equal to or larger than the above minimum, preferably the problem is not caused of lowering the degree to which the cellulose is activated. No upper limit is imposed on the amount of the activator added, as long as the amount doe not decrease the productivity. However, the amount of the activator added is preferably 100 times the amount of the cellulose or smaller, more preferably 20 times the amount of the cellulose or smaller, and particularly preferably 10 times the amount of the cellulose or smaller. Undue excess activator may be added to activate the cellulose, as long as the amount of the activator is decreased afterwards by doing an operation such as filtration, air blast drying, heat drying, distillation under reduced pressure or solvent replacement.

The time for an activation treatment is preferably 20 minutes or more. The uppermost limit of the activation time is not particularly limited as long as it does not effect upon the productivity; however, preferably 72 hours or less, more preferably 24 hours or less, and particularly preferably 12 hours or less. The temperature for activation is 0° C. to 90° C. (both inclusive), further preferably 15° C. to 80° C. (both inclusive), and particularly preferably 20° C. to 60° C. (both inclusive). The step of activating the cellulose can be performed under pressure or reduced pressure. As a heating device, electromagnetic wave such as microwave or infrared light may be used.

### (Acylation)

In the method for preparing a cellulose acylate of the present invention, preferably the hydroxyl group of the cellulose is acylated by adding an acid anhydride of carboxylic acid to the cellulose to allow them to react in the presence of a Brönsted acid or Lewis acid as a catalyst.

The cellulose mixed acylate in the present invention may be prepared by

a method of adding or sequentially supplying two types of carboxylic acid anhydrides to cellulose to react them;
a method of using an hydride of a mixture of two types of carboxylic acids (e.g., acetic acid/propionic acid anhydride mixture) to react with cellulose;

a method of synthesizing an acid anhydride mixture (e.g., acetic acid/propionic acid anhydride mixture) in the reaction system from a carboxylic acid and an acid anhydride of another carboxylic acid (acetic acid and anhydride of propionic acid) as starting materials and then reacting the mixture with cellulose; and

a method of once synthesizing cellulose acylate having a substitution degree of less than 3 and then acylating remaining hydroxy groups with an acid anhydride and an acid halide.

### (Acid Anhydride)

As an acid anhydride of carboxylic acid, mention preferably is made of a hydride of a carboxylic acid having 2 to 7 carbon atoms. Examples of acid anhydrides of such carboxylic acid include: acetic anhydride, propionic anhydride, butyric anhydride, 2-methylpropionic anhydride, valeric anhydride, 3-methylbutyric anhydride, 2-methylbutyric anhydride, 2,2-dimethylpropionic anhydride (pivalic anhydride), hexanoic anhydride, 2-methylvaleric anhydride, 3-methylvaleric anhydride, 4-methylvaleric anhydride, 2,2-dimethylbutyric anhydride, 2,3-dimethylbutyric anhydride, 3,3-dimethylbutyric anhydride, cyclopentanecarboxylic anhydride, heptanoic anhydride, cyclohexanecarboxylic anhydride and benzoic anhydride. Of these acid anhydrides, acetic anhydride, propionic anhydride, butyric anhydride, valeric anhydride, hexanoic anhydride and heptanoic anhydride are preferable, and acetic anhydride, propionic anhydride and butyric anhydride are particularly preferable.

In order to prepare a mixed ester, any of these acid anhydrides is preferably used together. Preferably the mixing ratio is determined depending on the replacing ratio of the intended mixed ester. Acetic anhydride is generally added to cellulose in an excessive amount. More specifically, acetic anhydride is added in an amount of 1.2 to 50 equivalents relative to a hydroxy group of cellulose, more preferably 1.5 to 30 equivalents, and particularly preferably, 2 to 10 equivalents.

(Catalyst)

As a catalyst for acylation used in production of cellulose acylate in the present invention, Brönsted acid or Lewis acid is preferably used. The definitions of Brönsted acid or Lewis acid are found in a physicochemistry dictionary “Rikagaku Jiten”, the 5th edition, (2000). Examples of preferred Brönsted acids include: sulfuric acid, perchloric acid, phosphoric acid, mechanesulfonic acid, benzenesulfonic acid and p-toluenesulfonic acid. Examples of preferred Lewis acids include: zinc chloride, tin chloride, antimony chloride and magnesium chloride.

More preferably sulfuric acid or perchloric acid is used as the catalyst, and sulfuric acid is particularly preferable. The preferable amount of a catalyst is 0.1 to 30% by weight relative to cellulose, more preferably 1 to 15% by weight, and particularly preferably, 3 to 12% by weight.

(Solvent)

In an acylation reaction, a solvent may be added in order to adjust viscosity, reaction rate, stirring property and acyl group substitution rate. As such a solvent, carboxylic acids are preferably mentioned, and for example, carboxylic acids having 2 to 7 carbon atoms (for example, as acetic acid, propionic acid, butyric acid, 2-methylpropionic acid, valeric acid, 3-methylbutyric acid, 2-methylbutyric acid, 2,2-dimethylpropionic acid (pivalic acid), hexanoic acid, 2-methylvaleric acid, 3-methylvaleric acid, 4-methylvaleric acid, 2,2-dimethylbutyric acid, 2,3-dimethylbutyric acid, 3,3-dimethylbutyric acid, cyclopentanecarboxylic acid) may be mentioned, although dichloromethane, chloroform, carboxylic acids, acetone, ethyl methyl ketone, toluene, dimethylsulfoxide, sulfolan, etc., may be used. More preferably, acetic acid, propionic acid, butyric acid, etc., may be mentioned. These solvents may be used in the form of admixture.

(Acylation Conditions)

In an acylation reaction, an acid anhydride and a catalyst, and if necessary, a solvent are mixed, and thereafter mixed with cellulose. Alternatively, they may be sequentially added, thereby individually and separately mixing with cellulose. Generally, it is preferable that a mixture of an acid anhydride and a catalyst or a mixture of an acid anhydride, catalyst and solvent is prepared as an acylating agent, and then, the acylating agent is reacted with cellulose. The acylating agent is preferably cooled in advance to suppress an increase of temperature within a reaction container due to heat generation during acylation reaction. The cooling temperature is preferably −50° C. to 20° C., more preferably −35° C. to 10° C., and particularly preferably −25° C. to 5° C. The acylating agent may be in the liquid state or frozen to the solid state in the form of crystals, flakes or blocks, when it is added.

An acylating agent may be added to cellulose at a time or in separate potions. Alternatively, cellulose may be added to an acylating agent at a time or in separate portions. When adding acylating agent in installments, either an acylating agent having the same composition or acylating agents having different compositions may be used. Preferred examples include: 1) first adding a mixture of an acid anhydride and a solvent and then adding catalyst; 2) first adding a mixture of an acid anhydride, a solvent and part of catalyst and then a mixture of the rest of catalyst and a solvent; 3) first adding a mixture of an acid anhydride and a solvent and then adding a mixture of catalyst and a solvent; and 4) first adding a solvent and then adding a mixture of an acid anhydride and catalyst or a mixture of an acid anhydride, catalyst and a solvent.

In the method for manufacturing a cellulose acylate of the present invention, preferably the peak temperature at the time of acylation is 50° C. or lower, though acylation of cellulose is an exothermic reaction. This is because when the reaction temperature is 50° C. or less, depolymerization does not proceed, with the result that cellulose acylate having an unappropriate polymerization degree is rarely obtained. The uppermost temperature that the acylation reaction reaches is preferably 45° C. or less, more preferably 40° C. or less, and particularly preferably, 35° C. or less. The reaction temperature may be controlled by using a temperature controller or controlled by the initial temperature of the acylating agent. The reaction temperature can also be controlled by reducing the pressure in a reactor and utilizing the evaporation heat of the liquid component in the reaction system. The reaction temperature can also be controlled by cooling the reaction system at the beginning of the reaction and then heating the same, because the exothermic heat at the time of acylation is larger at the beginning of the reaction. The end point of acylation can be determined by light transmittance, viscosity of solution, temperature change in reaction system, solubility of reaction product in an organic solvent or polarizing microscopy.

The lowermost temperature of the reaction is preferably −50° C. or more, more preferably −30° C. or more, and particularly preferably, −20° C. or more. The acylation time is preferably 0.5 hours and 24 hours (both inclusive), more preferably 1 to 12 hours (both inclusive) and particularly preferably, 1.5 to 6 hours (both inclusive). The acylation time 0.5 hours or shorter is not preferable because the reaction does not progress sufficiently and the reaction time longer than 24 hours is not preferable, either, in terms of industrial manufacture.

(Reaction Terminator)

In a method for manufacturing cellulose acylate to be used in the present invention, a reaction terminator may preferably be added following the acylation reaction.

Any reaction terminator may be added as long as it decomposes an acid anhydride. Preferable examples of such a reaction terminator include water, alcohol such as ethanol, methanol, propanol, isopropyl alcohol, and a composition containing these. A reaction terminator may include such a neutralizer as described later. To avoid trouble such that exothermic heat exceeding the cooling ability of the reactor is generated and contributes to lowering the polymerization degree of cellulose acylate or cellulose acylate precipitates in the undesirable form, it is preferable, when adding such a reaction terminator, not to directly add water or alcohol, but to add a mixture of water with a carboxylic acid such as acetic acid, propionic acid or butyric acid, and as the carboxylic acid, acetic acid is preferable. A carboxylic acid and water may be used in any ratio; however, the content of water is preferably within the range of 5% by weight to 80% by weight, further preferably 10% by weight and 60% by weight, and particularly preferably, 15% by weight to 50% by weight.

A reaction terminator may be added to the reactor for acylation or the reaction product may be added to the container containing a reaction terminator. Preferably a reaction terminator is added over 3 minutes to 3 hours. The addition of a reaction terminator over 3 minutes or longer is preferable, because it does not cause trouble such that exothermic heat becomes too large and contributes to lowering the polymerization degree of cellulose acylate, or the hydrolysis of an acid anhydride becomes insufficient, or the stability of cellulose acylate is lowered. The addition of a reaction terminator over 3 hours or shorter is also preferable, because it does not cause the problem of lowering the industrial productivity. The period of time over which a reaction terminator is added is preferably 4 minutes or longer and 2 hours or shorter, more preferably 5 minutes or longer and 1 hour or shorter, and particularly preferably 10 minutes or longer and 45 minutes or shorter. When adding a reaction terminator, it matters little whether the reactor is cooled or not; however, to suppress the occurrence of depolymerization, it is preferable to cool the reactor to suppress the temperature rise. It is also preferable to keep a reaction terminator in the cooled state before it is added.

### (Neutralization Agent)

To hydrolyze excess carboxylic anhydride or neutralize part of or the whole carboxylic acid or esterifying catalyst remaining in the system, a neutralization agent (e.g. a carbonate, acetate, hydroxide or oxide of calcium, magnesium, iron, aluminum or zinc) or the solution of a neutralization agent may be added during or after the step of terminating acylation reaction. Preferred examples of solvents for neutralization agent include: polar solvents such as water, alcohols (e.g. ethanol, methanol, propanol and isopropyl alcohol), carboxylic acids (e.g. acetic acid, propionic acid and butyric acid), ketones (e.g. acetone and ethyl methyl ketone), and dimethyl sulfoxide; and the mixed solvents thereof.

(Partial Hydrolysis)

The cellulose acylate thus obtained has an entire substitution rate close to 3. To obtain cellulose acylate having a desired degree of substation, the cellulose acylate is generally maintained in the presence of a small amount of a catalyst (generally, an acylating catalyst such as remaining sulfuric acid) and water at 20 to 90° C. for several minutes to several days to partially hydrolyze an ester bond, thereby reducing the substitution degree of cellulose acylate with an acylate group to a desired level. This is called as “maturation.” During the process of the partial hydrolysis, sulfate ester of cellulose undergoes hydrolysis; thus, the amount of sulfate ester bound to cellulose can be decreased by adjusting the hydrolytic conditions.

At the time point where a desired cellulose acylate is obtained, preferably, the remaining catalyst present in the reaction system is completely neutralized with a neutralization agent as mentioned above or its solution to terminate the partial hydrolysis. Alternatively, a neutralization agent such as magnesium carbonate, magnesium acetate, generating a salt having a low solubility in the reaction solution is preferably added to the reaction solution to effectively remove the catalyst (such as sulfuric ester) in the solution or bound to cellulose.

(Filtration)

The reaction mixture (dope) is preferably filtrated to remove or reduce an unreacted product in cellulose acylate, less-soluble salt and other foreign matters. Filtration is performed in any step from completion of acylation to reprecipitation. Prior to filtration, the reaction mixture is preferably diluted with an appropriate solvent to control filtration pressure and handling.

(Reprecipitation)

The cellulose acylate solution thus obtained is mixed with water or a poor solvent such as an aqueous solution of a carboxylic acid, acetic acid or propionic acid, or a poor solvent is mixed with the cellulose acylate solution to reprecipitate cellulose acylate. The reprecipitated cellulose is washed and applied by stabilization treatment to obtain desired cellulose acylate. The reprecipitation operation of the cellulose acylate solution is continuously performed or in a batch several times (predetermined amount per time). It is also preferable to control the form or molecular weight distribution of the reprecipitated cellulose acylate by adjusting the concentration of the cellulose acylate solution and the composition of the poor solvent depending on the manner in which the cellulose acylate undergoes replacement or the polymerization degree of the same.

(Washing)

The cellulose acylate thus produced is preferably washed. Any washing solvent may be used as long as it less dissolves cellulose acylate and can remove impurities; however, generally water or warm water is used. The temperature of the washing solution is preferably 25° C. to 100° C., more preferably 30° C. to 90° C., particularly preferably 40° C. to 80° C. The cleaning treatment may be performed by so-called batch process, in which filtration and replacement of cleaning solution are repeated, or by using continuous cleaning equipment. It is preferable to reuse the liquid waste produced in the steps of reprecipitation and cleaning as a poor solvent in the reprecipitation step or to recover the solvent such as carboxylic acid from the liquid waste by distillation or the like and reuse the same.

Proceeding of washing may be monitored by any means; however, preferably monitored by hydrogen ion concentration analysis, ion chromatography, electric conductivity analysis, ICP, element analysis, or atomic adsorption spectrum.

Such treatment makes it possible to remove the catalyst (such as sulfuric acid, perchloric acid, trifluoroacetic acid, p-toluene salfonic acid, methanesulfonic acid or zinc chloride), neutralizer (such as a carbonate, acetate, hydroxide or oxide of calcium, magnesium, iron, aluminum or zinc), reaction product of neutralizer and catalyst, carboxylic acid (such as acetic acid, propionic acid or butyric acid), or reaction product of neutralizer and carboxylic acid in the cellulose acylate. This is effective in enhancing the stability of the cellulose acylate.

(Stabilization)

Cellulose acylate after washed with warm water is preferably treated also with an aqueous solution of weak alkali such as carbonate, hydrogen carbonate, hydroxide or oxide of sodium, potassium, calcium, magnesium, or aluminium in order to further improve stability or reduce the odor of carboxylic acid.

The amount of the residual impurities can be controlled by the amount of cleaning solution, the temperature and time of cleaning, the method of stirring, the shape of cleaning vessel, and the composition or concentration of stabilizer. In the present invention, the conditions of acylation, partial hydrolysis and cleaning are set so that the amount of the residual sulfate group (in terms of the content of sulfur atom) is in the range of 0 to 500 ppm.

(Drying Step)

In the present invention, to control the water content of cellulose acylate to a preferable amount, it is preferred to dry cellulose acylate. Drying can be performed by any method, as long as an intended moisture content is obtained. However, preferably it is performed using any one of heating, air blast, reduced pressure or stirring alone or two or more of them in combination. A drying step is preferably performed at a temperature of 0 to 200° C., further preferably 40 to 180° C., and particularly preferably 50 to 160° C. The cellulose acylate of the present invention preferably has a water content of not more than 2% by weight or less, further preferably not more than 1% by weight, and particularly preferably, not more than 0.7% by weight.

(Configuration)

The cellulose acylate of the present invention may take various shapes such as granular, powdery, fibrous, and weightive forms. Granular or powdery shape is preferable as a raw material for producing a film. Therefore, cellulose acylate after dry may be pulverized or sieved to improve homogeneity of particles and handling thereof. When cellulose acylate takes a particle shape, not less than 90% by weight of the particles preferably has a particle size of 0.5 to 5 mm. Furthermore, not less than 50% by weight of the particles to be used preferably has a particle size of 1 to 4 mm. It is preferred that the shape of cellulose acylate particles is as circular as possible. The cellulose acylate particles to be used in the present invention preferably has an apparent density of 0.5 to 1.3, further preferably 0.7 to 1.2, and particularly preferably, 0.8 to 1.15. A method of measuring an apparent density is defined in the JIS (Japanese Industrial Standard) K-7365.

The cellulose acylate particles of the present invention preferably have a repose angle of 10 to 70°, further preferably 15 to 600, and particularly preferably, 20 to 50°.

(Polymerization Degree)

The polymerization degree of cellulose acylate preferably used in the present invention is 100 to 300, preferably 120 to 250, and further preferably 130 to 200 in average. The average polymerization degree is measured, for example, by a limiting viscosity method proposed by Uda et al. (Kazuo Uda, Hideo Saito, the official journal of the Society of Fiber Science and Technology, Japan, Vol. 18, No. 1, page 105 to 120, 1962) and gel permeation chromatography (GPC). These methods are more specifically described in Japanese Patent Application Laid-Open No. 9-95538.

In the present invention, the weight average polymerization degree/number average polymerization degree obtained by subjecting a cellulose acylate to GPC is preferably 1.6 to 3.6, more preferably 1.7 to 3.3, and particularly preferably 1.8 to 3.2.

Either any one kind of these cellulose acylates alone or two or more of kinds of them in combination may be used. A cellulose acylate into which a polymer component other than a cellulose acylate is properly mixed may also be used. Preferably the polymer component mixed into a cellulose acylate is highly compatible with a cellulose ester and, when the cellulose acylate with the polymer component is formed into a film, the transmittance of the film is preferably 80% or higher, more preferably 90% or higher and much more preferably 92% or higher.

### [Synthesis Examples of Cellulose Acylate]

Synthesis examples of cellulose acylate used in the present invention will be described below in detail; however, the present invention will not be limited to these.

### Synthesis Example 1

### Synthesis of Cellulose Acetate Propionate

150 g of cellulose (broadleaf pulp) and 75 g of acetic acid were taken into a 5 L separable flask equipped with a reflux unit, as a reactor, and vigorously stirred for 2 hours while heated in an oil bath whose temperature is adjusted to 60° C. The cellulose thus pretreated was swelled and crushed and took the form of fluff. The reactor was then placed in an iced water bath at 2° C. for 30 minutes so that the cellulose was cooled.

Separately, a mixture of 1545 g of propionic anhydride, as an acylating agent, and 10.5 g of sulfuric acid was prepared, and the mixture was cooled to −30° C. and added, at one time, to the reactor containing the above pretreated cellulose. After 30 minutes had elapsed, the internal temperature of the reactor was controlled, by increasing the temperature outside the reactor gradually, so that it reached 25° C. two hours after the addition of the acylating agent. The reactor was then cooled in an iced water bath at 5° C., the internal temperature was controlled so that it reached 10° C. 0.5 hours after the addition of the acylating agent and 23° C. two hours after the same, and the reaction mixture was stirred for 3 hours while keeping the internal temperature at 23° C. The reactor was then cooled in an iced water bath at 5° C. and 120 g of water-containing 25% by mass acetic acid having been cooled to 5° C. was added over 1-hour period. The internal temperature of the reactor was increased to 40° C. and stirred for 1.5 hours. Then, a solution obtained by dissolving magnesium acetate tetrahydrate in an amount, on the mole basis, two times of the amount of sulfuric acid in 50% by mass water-containing acetic acid was added to the reactor and stirred for 30 minutes. Then, 1 L of water-containing 25% by mass acetic acid, 500 mL of water-containing 3.3% by mass acetic acid, 1 L of water-containing 50% by mass acetic acid and 1 L of water were added in this order to precipitate cellulose acetate propionate. The resultant precipitate of cellulose acetate propionate was washed with hot water. The washing conditions were varied as to obtain different kinds of cellulose acetate propionate with different amount of residual sulfate group. After washing, each cellulose acetate propionate was put into an aqueous solution of 0.005% by mass calcium hydroxide at 20° C., stirred for 0.5 hours, further washed with water until the pH of the wash liquid reaches 7, and vacuum dried at 70° C.

The 1H-NMR and GPC measurements revealed that the degree of acetylization, degree of propionization and degree of polymerization of the resultant cellulose acetate propionate were 0.30, 2.63 and 320, respectively. The content of sulfate group was determined in accordance with ASTM D-817-96.

### Synthesis Example 2

### Synthesis of Cellulose Acetate Butyrate

100 g of cellulose (broadleaf pulp) and 135 g of acetic acid were taken into a 5 L separable flask equipped with a reflux unit, as a reactor, and allowed to stand for 1 hour while heated in an oil bath whose temperature is adjusted to 60° C. Then the mixture was stirred vigorously for 1 hour while heated in an oil bath whose temperature is adjusted to 60° C. The cellulose thus pretreated was swelled and crushed and took the form of fluff. The reactor was then placed in an iced water bath at 5° C. for 1 hour so that the cellulose was fully cooled.

Separately, a mixture of 1080 g of butyric anhydride, as an acylating agent, and 10.0 g of sulfuric acid was prepared, and the mixture was cooled to −20° C. and added at one time to the reactor containing the above described pretreated cellulose. After 30 minutes had elapsed, the mixture was allowed to react for 5 hours by increasing the temperature outside the reactor to 20° C. The reactor was then cooled in an iced water bath at 5° C., and 2400 g of water-containing 12.5% by mass acetic acid having been cooled to about 5° C. was added over one-hour. The internal temperature of the reactor was increased to 30° C. and the mixture was stirred for 1 hour. Then, 100 g of 50% by mass aqueous solution of magnesium acetate tetrahydrate was added to the reactor and stirred for 30 minutes. Then, 1000 g of acetic acid and 2500 g of water-containing 50% by mass acetic acid were added gradually to precipitate cellulose acetate butyrate. The resultant precipitate of cellulose acetate butyrate was washed with hot water. The washing conditions were varied to obtain different kinds of cellulose acetate butyrate with different amount of residual sulfate group. After washing, each cellulose acetate butyrate was put into an aqueous solution of 0.005% by mass calcium hydroxide, stirred for 0.5 hours, further washed with water until the pH of the wash liquid reaches 7, and dried at 70° C. The degree of acetylization, degree of butyrization and degree of polymerization of the resultant cellulose acetate butyrate were 0.84, 2.12 and 268, respectively.

(4) Other Additives

(i) Matting Agent

It is preferred to add fine particles as a matting agent. As the fine particles to be used in the present invention, mention may be made of silicon dioxide, titanium dioxide, aluminium oxide, zirconium oxide, calcium carbonate, talc, clay, calcined kaolin, calcined calcium silicate, hydrated calcium silicate, aluminum silicate, magnesium silicate and calcium phosphate. The fine particles contain silicon is preferable in view of lowering turbidity. In particular, silicon dioxide is preferably used. It is preferred that the fine particles of silicon dioxide have an average primary particle size of 20 nm or less and an apparent specific gravity of 70 g/L or more. The average primary particle size is more preferably as small as 5 to 16 nm because haze can be reduced. The apparent specific gravity is preferably 90 to 200 g/L and more preferably 100 to 200 g/L. The apparent specific gravity is larger, the more preferable. This is because a high-concentration dispersion solution can be prepared to improve haze and aggregation.

These fine particles usually form secondary particles having an average particle size of 0.1 to 3.0 μm. These secondary particles are present in the form of aggregates of primary particles on a film surface to contribute to producing convex-concave portions of 0.1 to 3.0 μm. The average secondary particle size is preferably 0.2 μm to 1.5 μm (both inclusive), further preferably 0.4 μm to 1.2 μm (both inclusive), and most preferably, 0.6 μm to 1.1 μm (both inclusive). The particle size of the primary and secondary particles is represented by the diameter of the circumscribed circle of a particle and measured under observation of a scanning electron microscope. The diameters of 200 particles were measured by changing the viewing field of the microscope to obtain an average particle size thereof.

As the fine particles of silicon dioxide, use may be made of commercially available products such as aerosil R972, R972V, R974, R812, 200, 200V, 300, R202, OX50, TT600 (these are all manufactured by Japan Aerosil Industry Co., Ltd.). As the fine particles of zirconium oxide, use may be made of commercially available products R976 and R811 (these are all manufactured by Japan Aerosil Industry Co., Ltd.).

Of them, aerosil 200V, aerosil R972V, which are fine particles of silicon dioxide having an average primary particle size of 20 nm or less and an apparent specific gravity of 70 g/L or more, are particularly preferable since they are effective in reducing abrasion coefficient while maintaining low turbidity of the resultant optical film.

(ii) Other Additives

Besides aforementioned additives, various additives such as a UV protective agent (e.g., a hydroxybenzophenone compound, benzotriazole compound, salicylic acid ester compound, and cyanoacrylate compounds), infrared absorber, optical regulator, surfactant, and odor-trapping agent (amine, etc.) may be added. Details of them are described in Technical Report No. 2001-1745, published on Mar. 15, 2001 by the Japan Institution of Invention and Innovation, pages 17 to 22) and materials described in this report may be preferably used.

As the infrared absorber, those described in Japanese Patent Application Laid-Open No. 2001-194522 may be used. As the UV protective agent, those described in Japanese Patent Application Laid-Open No. 2001-151901 may be used. They each are preferably contained in an amount of 0.001 to 5% by weight relative to cellulose acylate.

As the optical regulator, a retardation regulator may be mentioned. As the retardation regulator, use may be made of those described in Japanese Patent Application Laid-Open Nos. 2001-166144, 2003-344655, 2003-248117, and 2003-66230. The in-plane retardation (Re) and thickness-direction retardation (Rth) can be controlled by the retardation regulator. The addition amount of the retardation regulator is preferably 0 to 10 wt %, more preferably 0-8 wt % by weight, and further preferably 0-6 wt %.

(5) Physical Properties of Cellulose Acylate Mixture

The cellulose acylate mixture (containing cellulose acylate, plasticizer, stabilizer and other additives) preferably satisfies the following physical properties.

(i) Loss in Weight

In the thermoplastic cellulose acetate propionate composition of the present invention, the loss on heating at 220° C. is 5% by weight or lower. Here, the ratio of heating loss refers to the ratio of weight loss of a sample at a temperature of 220° C. when the sample is heated from room temperature at a temperature-increasing rate of 10° C./minute under nitrogen gas atmosphere. When the cellulose acylate mixture mentioned above is prepared, the ratio of heating loss can be preferably controlled within the range of not more than 5% by weight, more preferably not more than 3% by weight, and further preferably not more than 1% by weight. By virtue of this, damage such as bubbles produced during a film formation step can be suppressed.

(ii) Melt Viscosity

The thermoplastic cellulose acetate propionate composition of the present invention preferably has a melt viscosity per sec at 220° C. of 100 to 1000 Pa·s, more preferably 200 to 800 Pa·s, and further preferably 300 to 700 Pa·s. When the melt viscosity of the cellulose acylate mixture is set as high as mentioned above, the tensile extension (drawing) of a melt occurring at the outlet of a die can be prevented, successfully preventing an increase of optical anisotropy (retardation) due to orientational ordering caused by the drawing.

The viscosity can be controlled by any method; however controlled by varying the polymerization degree of cellulose acylate and the amount of additional agents such as a plasticizer.

(6) Melt Film Formation

(i) Dry Step

To control the water content of cellulose acylate in the present invention, it is preferably to dry the cellulose acylate. A dehumidification air drier is frequently used in drying cellulose acylate, but not particularly limited thereto as long as a desired water content is obtained. It is preferred that cellulose acylate is efficiently dried by a device such as heating, blasting, pressure reduction, and stirring, singly or in combination. Further preferably a heat-insulated dry hopper is constructed. The drying temperature is preferably 0 to 200° C., further preferably 40 to 180° C., and particularly preferably 60 to 150° C. It is not preferable that the drying temperature is too low, because not only long time is required for dry but also a desired water content is not obtained. It is also not preferable that the drying temperature is too high, because the resin becomes sticky, causing blocking. The dry-air amount is preferably 20 to 400 m³/hour, further preferably 50 to 300 m³/hour, and particularly preferably 100 to 250 m³/hour. It is not preferable that the amount of dry air is low, because the drying rate is low. On the other hand, even if the amount of dry air is increased, further drastic improvement in drying rate is not expected when the dry-air amount exceeds over a certain level. Therefore, increasing the amount of dry air is unfavorable in an economic point of view. The dew point of air is preferably 0° to −60° C., further preferably −10 to −50° C., and particularly preferably −20 to −40° C. As the drying time, at least 15 minutes is preferably required, and further preferably 1 hour or more, and particularly preferably, 2 hours or more. On the other hand, when pellets are dried beyond 50 hours, the effect of reducing water content is not expected and thermal deterioration of a resin may occur. For the reason, it is not preferable that the drying step is performed for unnecessarily long time. According to the cellulose acylate of the present invention, the water content is preferably not more than 1.0% by weight, further preferably not more than 0.1% by weight, and particularly preferably, 0.01% by weight.

(ii) Melt-Extruding

The cellulose acylate resin is supplied through a supply port of an extruder into the cylinder. The inside of the cylinder consists of: a feeding section where the cellulose acylate resin fed through the feed opening is transported in a fixed amount (area A); a compressing section where the cellulose acylate resin is melt-kneaded and compressed (area B); and a measuring section where the melt-kneaded and compressed cellulose acylate resin is measured (area C), from the feed opening side in this order. The cellulose acylate resin is preferably dried to reduce the water content thereof by a method as mentioned above. To prevent oxidization of a molten resin with the residual oxygen, it is preferable that the drying step is performed in an inert gas such as nitrogen or in vacuum while exhausting an extruder with ventilation. The screw compression ratio of the extruder is set at 2.5 to 4.5 and the L/D ratio is set at 20 to 70. The term “screw compression ratio” herein used means the volume ratio of the feeding section A to the measuring section C, in other words, the volume per unit length of the feeding section A÷the volume per unit length of the measuring section C, which is calculated using the outside diameter d1 of the screw shaft of the feeding section A, the outside diameter d2 of the screw shaft of the measuring section C, the diameter a1 of the channel of the feeding section A, and the diameter a2 of the channel of the measuring section C. The L/D ratio refers to the ratio of the length to the inner diameter of the cylinder. Furthermore, the extrusion temperature is set at 190 to 240° C. When the inner temperature of the extruder exceeds 240° C., it is better to provide a cooler between the extruder and the die.

If the screw compression ratio is as small as less than 2.5, melt-kneading is not sufficiently performed, causing an unmolten part, or the magnitude of heat evolution by shear stress is too small to sufficiently fuse crystals, making fine crystals more likely to remain in the formed cellulose acylate film. Furthermore, the cellulose acylate film is made more likely to include air bubbles. As a result, the cellulose acylate film having decreased strength is produced, or in stretching of the cellulose acylate film, the remaining crystals inhibit the stretchability of the film, whereby it cannot be sufficiently oriented. Conversely, if the screw compression ratio is as high as more than 4.5, the magnitude of heat evolution by shear stress is so large that the resin becomes more likely to deteriorate, which makes the cellulose acylate film more likely to yellow. Further, too large shear stress causes molecule breakage, which results in decrease in molecular weight, and hence in mechanical strength of the film. Accordingly, to make the manufactured cellulose acylate film less likely to yellow and less likely to break in stretching, the screw compression ratio is preferably in the range of 2.5 to 4.5, more preferably in the range of 2.8 to 4.2, and particularly preferably in the range of 3.0 to 4.0.

When the L/D is too small as low as less than 20, the mixture is not sufficiently melted or kneaded, with the result that fine crystals tend to leave in the resultant cellulose acylate film as in the case of a compression ration being small. Conversely, when the L/D is too large as high as more than 55, the retention time of cellulose acylate resin in the extruder becomes too long, with the result that deterioration of the resin is likely to cause. Furthermore, when the retention time becomes long, molecules tend to break, with the result that the molecular weight reduces, weakening mechanical strength of the resultant cellulose acylate film. Accordingly, to suppress the resultant cellulose acylate film from turning yellow and form a strong film sufficient to prevent breakage of the film by drawing, the L/D ratio preferably falls within the range of 20 to 55, more preferably 22 to 50, and particularly preferably, 24 to 45.

The extrusion temperature is preferably set at the aforementioned temperature range. The cellulose acylate film thus obtained has characteristic values a haze of 2.0% or less and a yellow index (Y1 value) of 10 or less.

The haze used herein is an index to know whether the extrusion temperature is too low, in other words, an index to know the level of crystal amount remaining in the resultant cellulose acylate film. When a haze value exceeds 2.0%, the mechanical strength of the resultant cellulose acylate film decreases and breakage of the film tend to take place by drawing. On the other hand, the yellow index (Y1 value) serves as an index to know whether the extrusion temperature is too high. When a yellow index (Y1 value) is 10 or less, no problem is produced with respect to yellow coloring.

Note that a diameter of a screw varies depending upon the desired extrusion amount per unit time, preferably 10 mm to 300 mm (both inclusive), more preferably 20 mm to 250 mm (both inclusive) and further preferably 30 mm to 150 mm.

(iii) Filtration

To remove foreign matter from a resin and to prevent foreign matter from damaging gear pump, so-called breaker plate type filtration is preferably performed by providing a filter in the outlet of an extruder. Furthermore, to remove foreign matter efficiently, a filter device having a leaf-type disc filter installed therein is preferable provided downstream of a gear pump. A filtration filter may be provided a single site (single-stage filtration) or a plurality of sites (multiple-stage filtration). The higher the filtration accuracy of the filter, the better. However, in view of the withstand pressure of a filter and filtration pressure increased by filter clogging, the filtration accuracy is preferably 15 to 3 μm, and further preferably 10 to 3 μm. In particular, when a leaf-type disk filter is used in the final stage of filtration, a filter material having high filtration accuracy is preferably used from a quality point of view. The filtration accuracy can be controlled by varying the number of filters in view of appropriately maintaining withstand pressure and service life of a filter. Since the filter is used under high temperature/high pressure conditions, a filter formed of an iron steel material is preferably used. Of the iron steel materials, stainless steel and steel are particularly preferably used as the material. In consideration of corrosion, a stainless steel is desirably used. The filter may be a knitting of a line material and sintered filter formed by sintering long metal fiber or metal powder may be employed. In view of filtration accuracy and filter service life, the sintered filter is preferable.

(iv) Gear Pump

To improve the thickness accuracy of a film, it is important to reduce variance in ejection amount. To attain this, it is effective to provide a gear pump between the extruder and the die to supply cellulose acylate resin at a constant rate. The gear pump consists of a pair of gears: a driving gear and a driven gear, mutually engaged and housed in a pump. When the driving gear is driven, the driven gear engaged with the driving gear is rotated to suck molten resin into the cavity of the pump through a suction port formed in a housing and then the molten resin is ejected from an ejection port formed in the housing at a constant rate. Even if the resin is extruded at a different pressure from the tip portion of the extruder, the difference is absorbed by use of a gear pump. As a result, the variance in pressure of the resin is reduced downstream of the film formation apparatus, thereby improving dimensional difference in the thickness direction. The use of a gear pump makes it possible to keep the fluctuation of the resin pressure at the die within the range of ±1%.

Another method may also be employed to supply resin by the gear pump at a more constant rate. In this method, the pressure of the resin upstream of the gear pump is controlled constant by varying the rotation number of the screw. Alternatively, a method using an accurate gear pump using not less than three gears is effective since variance of gears can be overcome.

There are other merits when a gear pump is used. Since a film is formed while reducing the pressure of tip portion of the screw, it is expected to reduce energy consumption, prevent a temperature increase and improve the transportation efficiency of resin, reduce retention time of resin in the extruder and the L/D ratio of the extruder. When a filter is used to remove foreign matter, the amount of resin supplied from a screw may vary as filtration pressure increases, if a gear pump is not used. However, this phenomenon can be overcome by use of the gear pump in combination. On the other hand, demerits of using a gear pump are such that: it may increase the length of the equipment used, depending on the selection of equipment, which results in a longer detention of the resin in the equipment; and the shear stress generated at the gear pump portion may cause the breakage of molecule chains. Thus, care must be taken when using a gear pump.

The retention time of resin supplied through the supply port of the extruder and ejected from the die is preferably 2 minutes to 60 minutes (both inclusive), more preferably 3 minutes to 40 minutes (both inclusive), and further preferably 4 minutes to 30 minutes (both inclusive).

When a polymer circulating through bearing of the gear pump does not flow smoothly, the sealing performance by the polymer in a driving section and the bearing section degrades, causing problems such as variable measurement and large fluctuation of resin extrusion pressure. To overcome these problems, the gear pump must be designed (particularly paying attention to clearance) taking the melt viscosity of cellulose acylate resin into consideration. In some cases, the cellulose acylate resin remaining in the gear pump causes deterioration. Therefore, the structure of the gear pump must be designed such that resin retained as little as possible. Also, a polymer pipe and adapter connecting the extruder and the gear pump or the gear pump and the die must be designed such that resin is retained as little as possible. In addition, to stabilize the extrusion pressure of cellulose acylate resin whose melt viscosity is highly dependent upon temperature, it is preferred that temperature fluctuation is reduced as much as possible. In general, to warm a polymer pipe, a band heater (inexpensive in equipment cost) is frequently used, more preferably an aluminium cast heater (lower in temperature change) is used. Furthermore, to stabilize the ejection pressure of the extruder, a heater which is divided into 3 to 20 sections is preferably provided around the barrel of the extruder to melt the resin.

(v) Die

Cellulose acylate resin is melted by the extruder having the aforementioned structure and the molten resin is continuously fed to a die by way of, if necessary, a filter and a gear pump. Any type of die may be used as long as retention time of the molten resin in the die is short. Examples of the die include T die, fish-tale die and hanger-coat die. Furthermore, to increase temperature-uniformity of a resin, a static mixer may be provided upstream of the T-die. The clearance (lip clearance) of the outlet of the T-die is preferably 1.0 to 5.0 fold as large as film thickness in general, more preferably 1.2 to 3 fold, and further preferably 1.3 to 2 fold. When the lip clearance is less than 1.0 fold as low as film thickness, it is difficult to form a good planar sheet. In contrast, the lip clearance of more than 5.0 fold as large as film thickness is not preferable, because the direction accuracy of a sheet decreases. The die is an extremely important unit for determining the thickness accuracy of the resultant film. Therefore, it is preferably to employ a die capable of severely controlling the thickness accuracy of the resultant film. Generally, the thickness of a film can be controlled by a die at a pitch of 40 to 50 mm. A die preferably controls the thickness of a film at a pitch of 35 mm or less, and further preferably 25 mm or less. Since cellulose acylate resin has a high dependency of melt viscosity on temperature and sheering rate, it is important to design a die having a small difference in temperature and flow rate in the width direction as must as possible. Furthermore, a die equipped with an automatic thickness regulator is known, which is placed downstream of the die and measures the film thickness of the formed film, calculates the deviation of thickness and feedbacks calculation results to the thickness regulator, thereby controlling film thickness. It is effective to employ such a die to reduce difference in film thickness in a long-term continuous production.

A single layer forming apparatus cheep in equipment cost is generally used in forming a film. In some cases, a multiple layer forming apparatus may be used for forming a film formed of two layers different in type in the case of forming a functional layer as an outside layer. Generally, the functional layer is preferably formed as a thin layer on the surface; however, the thickness ratio of layers is not particularly limited.

(vi) Cast

A molten resin extruded onto sheet from a die is solidified on a cooling drum to obtain a film. At this time, the adhesion between the cooling drum and the extruded sheet is preferably improved by a method such as an electrostatic application method, air knife method, air chamber method, vacuum nozzle method or touch roll method. Such a method for improving adhesion may be applied to whole or part of the surface of the extruded sheet. In particular, a method called “edge pinning” is frequently employed for adhering only both edges of the sheet onto the cooling drum. However, the method of adhering the edges is not limited to this.

More preferably the sheet is gradually cooled by use of a plurality of cooling drums. Particularly three cooling drums are generally and frequently used but not limited to these. The diameter of the cooling drum is preferably 100 mm to 1000 mm (both inclusive), and more preferably 150 mm to 1000 mm (both inclusive). The intervals between cooling drums is preferably 1 mm to 50 mm (both inclusive), and more preferably 1 mm to 30 mm (both inclusive).

The temperature of the cooling drum is preferably 60° C. to 160° C. (both inclusive), more preferably 70° C. to 150° C. (both inclusive), and further preferably 80° C. to 140° C. (both inclusive). The cellulose acylate sheet is removed from the cooling drums and rolled up by way of nip rolls. The roll-up rate is preferably 10 m/minute to 100 m/minute (both inclusive), more preferably 15 m/minute to 80 m/minute (both inclusive), and further preferably 20 m/minute to 70 m/minute (both inclusive).

The width of a formed film is preferably 0.7 m to 5 m (both inclusive), more preferably 1 m to 4 m (both inclusive), and further preferably 1.3 m to 3 m (both inclusive). The thickness of the film (undrawn film) thus obtained is preferably 30 μm to 400 μm (both inclusive), more preferably 40 μm to 300 μm (both inclusive), and further preferably 50 μm to 200 μm (both inclusive).

When the touch roll method is employed, the surface of a touch roll may be formed of rubber, resin such as Teflon or metal. Furthermore, a so-called flexible roll may be used. Since the flexible roll is made of a thin metal roll, the surface of the roll is depressed and the contact area is widen when a film is touched on the flexible roll.

The temperature of the touch roll is preferably 60° C. to 160° C. (both inclusive), more preferably 70° C. to 150° C. (both inclusive), and further preferably 80° C. to 140° C. (both inclusive).

(vii) Roll Up

The sheet thus obtained is preferably trimmed at the both edges and rolled up. The trimmed edge portions may be crushed, if necessary, palletized and depolymerized/repolymerizd, and recycled as a raw material for the same type or different type of film. As a trimming cutter, any type of cutter selected from a rotary cutter, sheer cutter, and knife, may be used. Such a cutter that may be formed of any type of material selected from carbon steel and stainless steel, etc. may be used. Generally, an ultra-hard knife and ceramic knife are preferably used because the cutter can be used for a long time without generating powdery cut chip.

Prior to rolled up, a laminate film is preferably attached at least one of both surfaces in view of preventing damage. A preferable tension in rolling up is 1 kg/m width to 50 Kg/width (both inclusive), more preferably 2 kg/m width to 40 kg/width (both inclusive), and further preferably 3 kg/m width to 20 Kg/width (both inclusive). The tension is less than 1 kg/m width, it is difficult to roll up the film uniformly. Conversely, it is not preferable to apply tension in excess of 50 kg/width. This is because the film is rolled up tightly. As a result, the appearance of the roll becomes bad. Besides, a bump portion of the film extends due to a creeping phenomenon and causes waving, or the extended film causes residual birefringence. Tensile during the roll-up step is preferably detected by a tension controller provided in the middle of the production line and controlled so as to apply a constant tension to the film to be rolled up. In a film-formation line, if there is a place different in temperature, the film differs in length even slightly by thermal expansion. In this case, the ratio in drawing speed between nip rolls is controlled so as not to apply excessive tension over a predetermined value to the film in the middle of the production line.

Since the tension during a roll up step can be controlled by the tension controller, the film can be rolled up while applying a constant tension. Tension is preferably reduced with an increase of the diameter of a roll. In this manner, the film is preferably rolled up while applying an appropriate tension. In general, as the diameter of a roll increases, the tension is reduced little by little. However, it is sometimes preferred that the tension is increased as the roll diameter increases.

(viii) Physical Properties of Undrawn Cellulose Acylate Film

The undrawn cellulose acylate film thus obtained preferably has Retardation (Re) of 0 to 20 nm and retardation (Rth) of 0 to 80 nm, more preferably Re of 0 to 15 nm and Rth of 0 to 70 nm, and further preferably Re of 0 to 10 nm and Rth of 0 to 60 nm. Re and Rth represent in-plane retardation and retardation along the thickness, respectively. Re is measured by an analyzer, KOBRA 21ADH (Oji Scientific Instrument) with light incident upon the film in the normal-line direction. Rth is calculated based on retardation values measured in three directions. One is Re and others are retardation values measured by striking light at an incident angle of +400 and −40° relative to the normal line to the film (in this case, a delayed phase in the plane is used as a tilt axis (rotation axis)). Assuming that the angle formed between the film formation direction (length direction) and the delayed phase axis of Re of the film is represented by θ, θ is preferably closer to 0°, +90° or −90°.

The transmittance of the all optical light is preferably 90% to 100%, more preferably 91% to 99%, and further preferably 92% to 98%. The haze is preferably 0 to 1%, more preferably 0 to 0.8%, and further preferably 0 to 0.6%.

The difference in thickness in the length direction and the width direction each preferably falls within the range of 0% to 4% (both inclusive), more preferably 0% to 3% (both inclusive), and further preferably 0% to 2% (both inclusive).

The tensile elastic modulus is preferably 1.5 kN/mm² to 3.5 kN/mm² (both inclusive), more preferably 1.7 kN/mm² to 2.8 kN/mm² (both inclusive), and further preferably 1.8 kN/mm² to 2.6 kN/mm² (both inclusive).

The break (ductility) is preferably 3% to 100% (both inclusive), more preferably 5% to 80% (both inclusive), and further preferably 8% to 50% (both inclusive).

Tg of the film (which refers to Tg of a mixture of cellulose acylate and additives) is preferably 95° C. to 145° C. (both inclusive), more preferably 100° C. to 140° C. (both inclusive), and further preferably 105° C. to 135° C. (both inclusive).

The thermal dimensional changes of the film in the length and width direction at 80° C. per day, both are preferably 0% to ±1% (both inclusive), more preferably 0% to ±0.5% (both inclusive), and further preferably 0% to ±0.3% (both inclusive).

The water permeability of the film at 40° C. at a relative humidity of 90% is preferably 300 g/m²/day to 1000 g/m²/day (both inclusive), more preferably 400 g/m²/day to 900 g/m²/day (both inclusive), and further preferably 500 g/m²/day to 800 g/m²/day (both inclusive).

The equilibrium water content of the film at 25° C. at a relative humidity of 80% is preferably 1 wt % to 4 wt % (both inclusive), more preferably 1.2 wt % to 3 wt % (both inclusive), and further preferably 1.5 wt % to 2.5 wt % (both inclusive).

(8) Drawing

The film formed by a method as mentioned above may be drawn to control Re and Rth.

The drawing may be performed preferably at Tg to (Tg+50)° C. (both inclusive), more preferably (Tg+3)° C. to (Tg+30)° C. (both inclusive), and further preferably (Tg+5)° C. to (Tg+20)° C. (both inclusive). Drawing may be performed in at least one direction preferably at a rate of 1% to 300% (both inclusive), more preferably 2% to 250% (both inclusive), and further preferably 3% to 200% (both inclusive). Drawing is performed equally in the length and width directions; however preferably performed unequally. In other words, the drawing rate of one of the directions is preferably larger than the other. The drawing rate of either length direction or width direction may be larger; however, a smaller drawing rate is preferably 1% to 30% (both inclusive), more preferably 2% to 25% (both inclusive), and further preferably 3% to 20% (both inclusive). The larger drawing rate is preferably 30% to 300% (both inclusive), more preferably 35% to 200% (both inclusive), and further preferably 40% to 150% (both inclusive). Drawing may be performed in a single stage or multiple stages. Here, the drawing rate is obtained in accordance with the following equation:

Drawing rate (%)=100×{(length after drawing)−(length before drawing)}/(length before drawing)

Drawing may be performed by use of not less than two pairs of nip rolls in the longitudinal direction (longitudinal drawing) by setting the rotation speed (peripheral speed) of the roll at the side near the outlet larger. Alternatively, drawing may be performed in the perpendicular direction to the longitudinal direction (transverse drawing) while holding both edges of a film by a chuck. Furthermore, drawing can be performed simultaneously in both directions (biaxial drawing) as described in Japanese Patent Application Laid-Open No. 2000-37772, 2001-113591, and 2002-103445.

The ratio of Re and Rth can be freely controlled by controlling a length-width ratio obtained by dividing the length between nip rolls by a film width in the case of the longitudinal drawing. More specifically, a Rth/Re ratio is increased by reducing the length-width ratio. Alternatively, the ratio of Re and Rth can be controlled by the longitudinal drawing and transverse drawing in combination. More specifically, Re may be reduced by reducing the difference between the longitudinal drawing rate and the transverse drawing rate. Conversely, Re may be increased by increasing the difference.

Re and Rth of the cellulose acylate film thus drawn preferably satisfy the following equations:

Rth≧Re

200 nm≧Re≧0

500 nm≧Rth≧30

more preferably

Rth≧Rex 1.1

150 nm≧Re≧10

400 nm≧Rth≧50

and further preferably

Rth≧Rex 1.2

100 nm≧Re≧20

350 nm≧Rth≧80

The angle formed between the film formation direction (longitudinal direction) and the delayed phase axis of Re of the film is preferably closer to 0°, +90° or −90°. To explain more specifically, in the longitudinal drawing, the angle is preferably closer to 0°. The angle is preferably 0°±3°, more preferably 0°±2°, and further preferably 0°±1°. In the case of the transverse drawing, the angle is preferably 90°±3° or −90°±3°, more preferably 900°±2° or −90°±2°, and further preferably 90°±1° or −90°±1°.

The thickness of the cellulose acylate film after drawing is 15 μm to 200 μm (both inclusive), more preferably 30 μm to 170 μm (both inclusive), and further preferably 40 μm to 140 μm (both inclusive). The difference in thickness in the longitudinal direction and width direction each is preferably 0% to 3% (both inclusive), more preferably 0% to 2% (both inclusive), and further preferably 0% to 1% (both inclusive).

The physical properties of the cellulose acylate film after drawing preferably fall within the following range.

The tensile elastic modulus is preferably 1.5 kN/mm² or more to less than 3.0 kN/mm², more preferably 1.7 kN/mm to 2.8 kN/mm² (both inclusive) and further preferably 1.8 kN/mm² to 2.6 kN/mm² (both inclusive).

The break (ductility) is preferably 3% to 100% (both inclusive), more preferably 5% to 80% (both inclusive), and further preferably 8% to 50% (both inclusive).

Tg of the film (which refers to Tg of a mixture of cellulose acylate and additives) is preferably 95° C. to 145° C. (both inclusive), more preferably 100° C. to 140° C. (both inclusive), and further preferably 105° C. to 135° C. (both inclusive).

The thermal dimensional change of the film at 80° C. per day both in the length and width directions is preferably 0% to ±1% (both inclusive), more preferably 0% to ±0.5% (both inclusive), and further preferably 0% to ±0.3% (both inclusive).

The water permeability of the film at 40° C. at a relative humidity of 90% is preferably 300 g/m²/day to 1000 g/m²/day (both inclusive), more preferably 400 g/m²/day to 900 g/m²/day (both inclusive), and further preferably 500 g/m²/day to 800 g/m²/day (both inclusive).

The equilibrium water content of the film at 25° C. at a relative humidity 80% is preferably 1 wt % to 4 wt % by weight (both inclusive), more preferably 1.2 wt % to 3 wt % (both inclusive), and further preferably 1.5 wt % to 2.5 wt % (both inclusive).

The thickness is 30 μm to 200 μm (both inclusive), more preferably 40 μm to 180 μm (both inclusive), and further preferably 50 μm to 150 μm (both inclusive).

The haze is preferably 0% to 3% (both inclusive), more preferably 0% to 2% (both inclusive), and further preferably 0% to 1% (both inclusive).

The transmittance of the all optical light is preferably 90% to 100% (both inclusive), more preferably 91% to 99% (both inclusive), and further preferably 92% to 98% (both inclusive).

(9) Surface Treatment

Undrawn and drawn cellulose acylate films can be improved in adhesion to a functional layer such as an undercoating layer and a backing layer) by applying surface treatment thereto. Examples of the surface treatment include glow discharge treatment, ultraviolet irradiation treatment, corona treatment, flame treatment, acid treatment and alkali treatment. The glow discharge treatment may be low-temperature plasma generating at a low pressure gas of 10⁻³ to 20 Torr or a plasma under the atmospheric pressure. A gas excited by a plasma under the aforementioned conditions, that is, a plasma excitation gas, which includes argon, helium, neon, krypton, xenon, nitrogen, carbon dioxide, from such as tetrafluoromethane and mixtures thereof. These gases are described in Technical Report No. 2001-1745, published on Mar. 15, 2001 by the Japan Institution of Invention and Innovation, pages 30 to 32). In a plasma treatment performed under the atmospheric pressure recently drawn attention, an irradiation energy of 20 to 500 Kgy is used under 10 to 1000 kev, and more preferably an irradiation energy of 20 to 300 Kgy is used under 30 to 500 kev. Of the surface treatments mentioned above, alkali saponification is particularly preferable and effective for treating the surface of a cellulose acylate film. More specifically, the alkali saponification treatments described in Japanese Patent Application Laid-Open Nos. 2003-3266, 2003-229299, 2004-322928, and 2005-76088 may be employed.

In the alkaline saponification, a film may be soaked in a saponification solution or coated with a saponification solution. In the soaking method, a film is soaked in an aqueous solution of NaOH or KOH (pH10 to 14) placed in a vessel heated to 20 to 80° C. for 0.1 to 10 minutes, neutralized, washed with water and dried.

Examples of the coating method include a dip-coating method, curtain coating method, extrusion coating method, bar coating method and E-type coating method. A solvent used in the alkali saponification coating solution preferably has good wettability in order to coat the saponification solution onto a transparent substrate and maintains the surface state in good conditions without forming convex-concave portions in the surface of the transparent substrate. More specifically, alcoholic solvent is preferable and isopropyl alcohol is particularly preferable. Alternatively, an aqueous surfactant solution may be used as a solvent. The alkali of the alkali saponification coating solution is preferably dissolved in the aforementioned solvent and KOH and NaOH are further preferable. The pH of the saponification coating solution is preferably 10 or more, and further preferably 12 or more. The alkaline saponification reaction is preferably performed at room temperature for 1 second to 5 minutes (both inclusive), further preferably 5 seconds to 5 minutes (both inclusive), and particularly preferably, 20 seconds to 3 minutes (both inclusive). After the alkali saponification reaction, the surface coated with the saponification solution is preferably washed with water or acid, and then, washed with water. The saponification coating treatment and removing coating from an orientation film (described later) can be continuously performed to reduce the number of production steps. These saponification methods are more specifically described in Japanese Patent Application Laid-Open No. 2002-82226 and WO02/46809.

An undercoating layer may be provided for adhering a cellulose acylate film to a functional layer. The undercoating layer may be coated after the surface treatment is performed or without performing the surface treatment. The undercoating layer is described in Technical Report No. 2001-1745, published on Mar. 15, 2001 by the Japan Institution of Invention and Innovation, page 32).

These surface-treatment and undercoating steps may be integrated in a final stage of the film formation step or separately performed by itself. Alternatively, it can be performed in a functional layer imparting step (described later).

(10) Functional Layer

It is preferable that a functional layer, which is specifically described in Technical Report No. 2001-1745, published on Mar. 15, 2001 by the Japan Institution of Invention and Innovation, pages 32-45), is used in combination with drawn and undrawn cellulose acylate films according to the present invention. Of the functional layers described in the report, use preferably may be made of a polarizing layer (polarizer), optical compensation layer (optical compensation film) and antireflection imparting layer (anti-reflective film) and hard coating layer.

(i) Polarizing Layer (Formation of Polarizer)

Materials for Polarizing Layer

A polarizing layer presently on the market is generally formed by soaking a drawn polymer in a bath containing a solution of iodine or a dichromatic dye to impregnate a binder used in the polarizing layer with the iodine and dichromatic dye. Alternatively, a polarizing film formed by coating, for example, a polarizing film manufactured by Optiva Inc. may be used. The iodine and dichromatic dye in the polarizing film are orientationally ordered in the binder to express polarization. Examples of the dichromatic dye include an azo dye, stilbene dye, pyrazolone dye, triphenylmethane dye, quinoline dye, oxazine dye, thiazine dye and anthraquinone dye. The dichromatic dye is preferably water-soluble and preferably has a hydrophilic substituent such as sulfo, amino, hydroxyl groups. More specifically, use may be made of the compounds described in Technical Report No. 2001-1745, published on Mar. 15, 2001 by the Japan Institution of Invention and Innovation, page 58.

As the binder of the polarizing film, a self-crosslinkable polymer or a polymer crosslinkable with the aid of a crosslinking agent may be used. These binders may be used in combination. Examples of the binder include a methacrylate copolymer, styrene copolymer, polyolefin, polyvinyl alcohol, modified polyvinyl alcohol, poly(N-methylolacrylamide), polyester, polyimide, vinyl acetate copolymer, carboxymethylcellulose, and polycarbonate, which are described in, for example, Japanese Patent Application Laid-Open Nos. 8-338913 (the specification, paragraph [0022]). A silane coupling agent is also used as a polymer. As the polymer, use may be preferably made of a water-soluble polymer such as poly(N-methylolacrylamide), carboxymethylcellulose, gelatin, polyvinyl alcohol, and modified polyvinyl alcohol; more preferably gelatin, polyvinyl alcohol and modified polyvinyl alcohol; and most preferably, polyvinyl alcohol and modified polyvinyl alcohol. Particularly preferably, two types of polyvinyl alcohols or modified polyvinyl alcohols different in polymerization degree may be used in combination. Degree of saponification of polyvinyl alcohol is preferably 70 to 100%, and more preferably 80 to 100%. Degree of polymerization of a polyvinyl alcohol is preferably 100 to 5000. The modified polyvinyl alcohol is described in Japanese Patent Application Laid-Open Nos. 8-338913, 9-152509 and 9-316127. Not less than two types of polyvinyl alcohols and modified polyvinyl alcohols may be used in combination.

The lowermost limit of the thickness of the binder is preferably 10 μm. The thinner the binder, the better in view of light leakage from a liquid crystal display device. Therefore, the uppermost limit of the thickness of the binder is preferably equal to or thinner than that of a polarizer now on the market (about 30 μm), more preferably 25 μm or less, and further preferably 20 μm or less.

The binder of the polarizing film may be crosslinked. A polymer or monomer having a crosslinkable functional group may be added to the binder or a self-crosslinkable functional group may be added to the binder polymer. Crosslinking may be mediated by light, heat or pH change. In this way, a binder having a crosslinking structure can be formed. As to the crosslinking agent, there is a description in the specification of U.S. reissued Pat. No. 23297. Alternatively, a boron compound such as boric acid and borax may be used as a crosslinking agent. The addition amount of a crosslinking agent to the binder is preferably 0.1% to 20% by weight relative to the binder. If a crosslinking agent is added within the range, the orientation of a polarizing element and moist-heat resistance of the polarizing film can be satisfactory.

After compression of a crosslinking reaction, unreacted crosslinking agent preferably remains in an amount of not more than 1.0% by weight, and more preferably not more than 0.5% by weight. If this condition is satisfied, the weather resistance of the polarizing film can be improved.

[Drawing of Polarizing Film]

A polarizing film is preferably stained with iodine or a dichromatic dye after it is drawn (drawing method) or rubbed (rubbing method).

In the drawing method, the draw ratio of a polarizing film is preferably 2.5 to 30.0 fold, and more preferably 3.0 to 10.0 fold. A film may be drawn in the air (dry drawing) or by soaking in water (wet drawing). The draw ratio of the film is preferably 2.5 to 5.0 fold in the dry drawing and 3.0 to 10.0 fold in the wet drawing. The drawing is performed in the parallel to the machine direction (parallel drawing) or diagonally (diagonal drawing). The drawing may be performed in a single step or a plurality of steps. Drawing performed in a plurality of steps is advantageous since the film is drawn uniformly even if the draw ratio is high. More preferably drawing is performed diagonally by tilting the film at an angle of 10° to 80°

(I) Parallel Drawing

Prior to drawing, a PVA film is swollen. Degree of swelling is 1.2 to 2.0 fold (the weight ratio before swelling to after swelling). Thereafter, the PVA film is (continuously) fed via guide rolls and the like to a bath containing an aqueous medium or a dichromatic dye, in which the PVA film is drawn at a temperature of 15 to 50° C., preferably 17 to 40° C. The film is held by two pairs of nip rolls and drawn by rotating nip rolls such that the pair of nip rolls arranged downstream rotates faster than those arranged upstream. The draw rate refers to the ratio in length of the drawn film to the initial undrawn film (the same definition is used hereinafter). A preferably draw rate in view of the functional effects mentioned above is 1.2 to 3.5 fold, and more preferably 1.5 to 3.0 fold. After that, the drawn film is dried at 50° C. to 90° C. to obtain a polarizing film.

(II) Diagonal Drawing

A diagonal drawing method is described in Japanese Patent Application Laid-Open No. 2002-86554. In this method, a film is drawn diagonally by use of a tenter extending in the diagonal direction. Since a film is drawn in the air, the film must be impregnated with water in advance to make it easier to draw. The water content of the film is preferably 5% to 100% (both inclusive). The drawing is preferably performed at a temperature of 40° C. to 90° C. and at a relative humidity of 50% to 100% (both inclusive).

The absorption axis of the polarizing film thus obtained is preferably 10° to 80°, more preferably 30° to 60°, and further preferably 45° (40° to 50°) substantially.

[Adhesion]

After saponification, drawn or undrawn cellulose acylate film is adhered to a polarizing layer (film) to form a polarizer. The adhesion directions of the films are not particularly limited; however, the two films are preferably adhered such that the flow-casting axis (direction) of the cellulose acylate film is crossed with the drawing direction of the polarizing layer (film) at an angle with 0°, 45° or 90°.

The adhesive agent to be used herein is not particularly limited; however, includes a PVA resin (including a PVA modified with an acetoacetyl group, sulfonic acid group, carboxyl group, and oxyalkylene group) and an aqueous solution of boron compound. Of them, a PVA resin is preferable. The thickness of the adhesive agent layer is preferably 0.01 to 10 μm, and particularly preferably, 0.05 to 5 μm after dry.

Examples of the structure of the adhesion layer include:

### i) A/P/A

### ii) A/P/B

iii) A/P/T

### iv) B/P/B

### v) B/P/T

Note that A denotes an undrawn film according to the present invention; B a drawn film according to the present invention; T a cellulose triacetate film (Fujitack); P a polarizing layer. In the structures of i) and ii), A and B may be cellulose acetate films same or different in composition. In the case of iv), B and B may be cellulose acetate films same or different in composition and draw rate. Furthermore, when the adhesion layer is integrated into a liquid crystal display device, which side of the adhesion layer may be used at the side of a liquid crystal surface. In the cases of ii) and v), B is preferably arranged at the liquid crystal surface side.

When a polarizer is integrated into a liquid crystal display device, a substrate containing a liquid crystal is generally arranged between two polarizers. However, polarizers i) to v) according to the present invention and the general polarizer (T/P/T) may be freely combined. However, on the outermost display surface of the liquid crystal display device, a film such as a transparent hard coating layer, glare filter layer, and anti-reflective layer (as described later) may preferably be provided.

The higher the light transmittance of the polarizer thus obtained the more preferable. The higher the degree of polarization, the more preferable. The light transmittance of light having a wavelength of 550 nm through the polarizer preferably falls within the range of 30 to 50%, more preferably 35 to 50%, and most preferably, 40 to 50%. Degree of polarization of light having a wavelength of 550 nm through the polarizer preferably falls within the range of 90 to 100%, more preferably 95 to 100%, and most preferably, 99 to 100%.

When the polarizer thus obtained is stacked on a λ/4 board, circular polarization can be obtained. In this case, they are stacked such that the delayed phase axis of the λ/4 board and the absorption axis of the polarizer form an angle of 45°. At this time, the λ/4 board is not particularly limited; however, a λ/4 board having wavelength-dependent retardation (retardation decreases as the wavelength of light decreases). Furthermore, a polarizing film (polarizer) having an absorption axis tilted by 20° to 70° relative to the longitudinal direction and a λ/4 board formed of an optical anisotropic layer composed of a liquid crystal compound are preferably used.

A protecting film may be adhered to one of the surfaces of the polarizer, and a separating film to the other surface. The protecting film and the separating film are used in order to protect the polarizer when it is shipped and inspected.

(ii) Provision of Optical Compensation Layer (Formation of Optical Compensation Film)

An optical anisotropic layer serves for compensating a liquid crystal compound in a liquid crystal cell indicating black in a liquid crystal display device. The optical anisotropic layer is provided by forming an orientation film on a drawn or undrawn cellulose acylate film and further adding an optical anisotropic layer thereto.

[Orientation Film]

An orientation film is provided on a drawn or undrawn cellulose acylate film after the surface of the cellulose acylate film is treated. The orientation film plays a role in regulating the orientation direction of liquid crystal molecules. However, if liquid crystal molecules are orientationally ordered and then the orientation direction is fixed, the orientation film, which plays the same role as mentioned, is not required as an essential structural element. In short, a polarizer according to the present invention can be formed by transferring only an optical anisotropic layer, which is formed on the orientation film whose orientation state is fixed, onto a polarizer.

The orientation film can be formed by rubbing an organic compound (preferably a polymer), obliquely depositing an inorganic compound, forming a layer having a micro groove, or accumulating an organic compound (such as ω-tricosanoic acid, dioctadecyl-methylammonium chloride, methyl stearate) by the Langmuir Brojet method (LB film). Alternatively, an orientation film is known to exhibit orientation by applying an electric field or magnetic filed, or light irradiation.

The orientation film is preferably formed by rubbing a polymer. The polymer to be used in the orientation film is principally has a molecular structure capable of inducing orientational ordering of liquid crystal molecules.

In the present invention, the polymer having molecular structure capable of inducing orientational ordering of liquid crystal molecules is preferred to further has a side chain having a crosslinkable group (e.g., double bond) bound to the main chain, or a crosslinkable group capable of inducing orientational ordering of liquid crystal molecules introduced into a side chain.

The polymer to be used in the orientation film may be either a self-crosslinkable polymer or a polymer crosslinkable with the aid of a crosslinking agent. These polymers may be used in various combinations. Examples of these polymers include methacrylate copolymers, styrene copolymers, polyolefins, polyvinyl alcohol, modified polyvinyl alcohols, poly(N-methylolacrylamide), polyesters, polyimides, vinyl acetate copolymers, carboxymethylcellulose, and polycarbonates, which are described in, for example, Japanese Patent Application Laid-Open Nos. 8-338913 (the specification, paragraph [0022]). A silane coupling agent is also used as a polymer. A water-soluble polymer such as poly(N-methylolacrylamide), carboxymethylcellulose, gelatin, polyvinyl alcohol, and modified polyvinyl alcohols is preferably used. More preferably gelatin, polyvinyl alcohol and modified polyvinyl alcohols are used, and most preferably, polyvinyl alcohol and modified polyvinyl alcohols are used. Particularly preferably, two types of polyvinyl alcohols or modified polyvinyl alcohols different in polymerization degree may be used in combination. Degree of saponification of polyvinyl alcohol is preferably 70 to 100%, and more preferably 80 to 100%. Degree of polymerization of a polyvinyl alcohol is preferably 100 to 5000.

The side chain inducing orientational ordering of liquid crystal molecules generally has a hydrophobic group as a functional group. The type of a functional group actually used is determined depending upon the type of liquid crystal molecules and desired orientational ordering state. To explain more specifically, as a modification group for a modified polyvinyl alcohol may be introduced by a copolymerization reaction (copolymerization modification), chain transfer reaction (chain transfer modification) or a block polymerization reaction (block polymerization modification). Examples of the modification group include a hydrophilic group such as a carboxylic acid group, a sulfonic acid group, a phosphonic acid group, an amino group, an ammonium group, an amide group, and a thiol group; a hydrocarbon group having 10 to 100 carbon atoms; a hydrocarbon group having a fluorine atom substituent; a thioether group; a polymerizable group such as an unsaturated polymerizable group, an epoxy group, an aziridinyl group; and an alkoxy silyl group such as trialkoxy, dialkoxy, and monoalkoxy. Specific examples of these modified polyvinyl alcohols are described in, for example, Japanese Patent Application Laid-Open No. 2000-155216 (the specification, paragraphs [0022] to [0145]); and Japanese Patent Application Laid-Open No. 2002-62426 (the specification, paragraphs [0018] to [0022]).

When a side chain having a polymerizable functional group is bonded to the main chain of the polymer of an orientation film or when a crosslinkable function group is introduced into a side chain capable of inducing orientational ordering of liquid crystal molecules, the polymer of the orientation film and a multifunctional monomer contained in an optical anisotropic layer can be copolymerized. As a result, tight covalent bond is formed not only between a multifunctional polymer and a multifunction polymer but also between an orientation-film polymer and an orientation film polymer, as well as between a multifunctional monomer and an orientation-film polymer. Accordingly, introduction of a crosslinkable functional group into an orientation-film polymer remarkably improves the strength of an optical compensation film.

The crosslinkable functional group of the orientation-film polymer preferably contains a polymerizable group, similarly to a multifunctional monomer. Examples of the polymerizable group are described in, for example, Japanese Patent Application Laid-Open No. 2000-155216 (the specification, paragraphs [0080] to [0100]). The orientation-film polymer can be crosslinked with the aid of a crosslinking agent in place of using the crosslinkable functional group mentioned above.

Examples of the crosslinking agent include aldehyde, N-methylol compound, dioxane derivative, a compound which functions by activating carboxyl group, activated vinyl compound, activated halogen compound, isooxasol and dialdehyde starch. Not less than two types of crosslinking agents may be used together. Specific examples of the crosslinking agents are described in, for example, Japanese Patent Application Laid-Open No. 2002-62426 (the specification, paragraphs [0023] to [024]). Of them, highly reactive aldehyde, in particular, glutaraldehyde is preferable.

The addition amount of the crosslinking agent is preferably 0.1 to 20% by weight, and more preferably 0.5 to 15% by weight. The amount of crosslinking agent remaining unreacted in an orientation film is preferably not more than 1.0% by weight, and more preferably not more than 0.5% by weight. By limiting the addition amount of the crosslinking agent in this way, the orientation film acquires sufficient durability without generating reticulation, even if it is used in a liquid crystal display device for a long term and allowed to leave under a high-temperature and high-humidity atmosphere for a long time.

An orientation film is basically formed by applying a coating solution, which contains the polymer serving as an orientation film forming material and a crosslinking agent, onto a transparent substrate, heating it to dry (crosslinked), and rubbing the resultant polymer. The crosslinking reaction may be performed at any time after the coating solution is applied onto the transparent substrate. When a water-soluble polymer such as polyvinyl alcohol is used as the orientation film forming material, a mixture of an organic solvent (e.g., methanol) having a defoaming function and water is preferably used as the coating solution. The ratio of water to the organic solvent (methanol) is preferably 0:100 to 99:1 in terms of weight ratio, and more preferably 0:100 to 91:9. Use of the solvent mixture suppresses generation of bubbles, markedly reduces defects in the surface of the orientation film as well as the optical compensation layer (film).

As a coating method for the orientation film, mention may be preferably made of a spin coating method, dip coating method, curtain coating method, extrusion coating method, rod coating method and roll coating method. Of them, the rod coating method is particularly preferable. The thickness of the orientation film after dry is preferably 0.1 to 10 μm. Dry heating may be performed at 20° C. to 110° C. To obtain sufficient crosslinking, dry heating is preferably performed at a temperature of 60° C. to 100° C., and particularly preferably, 80° C. to 100° C. The dry heating may be performed for 1 minute to 36 hours, and preferably, 1 minute to 30 minutes. The pH of the coating solution is preferably set at an optimal value depending upon the crosslinking agent to be used. When glutaraldehyde is used, the pH of the coating solution is preferably 4.5 to 5.5, in particularly, preferably 5.

The orientation film is provided on a drawn or undrawn cellulose acylate film or on the undercoating layer mentioned above. The orientation film is obtained by crosslinking the polymer layer, followed by rubbing the surface of the polymer layer.

As the rubbing treatment, a rubbing method widely used in an orientational ordering step for a liquid crystal display (LCD) may be used. To explain more specifically, the surface of the film to be orientationally ordered is rubbed in a predetermined direction with paper, gauge, felt, rubber, nylon fiber or polyester fiber to make the film orientationally ordered. In general, a film can be orientationally ordered by rubbing the surface of the film for several times with cloth in which fibers same in length and thickness are uniformly planted.

When rubbing is performed on an industrial scale, a rotatory rubbing roll is brought into contact with a film having a polarizing layer attached thereto while transferring it. The rubbing roll preferably has a roundness, cylindricity, and deflection within 30 μm or less. The film preferably comes into contact with the rubbing roll with an angle (rubbing angle) of 0.1° to 90°. However, as described in Japanese Patent Application Laid-Open No. 8-160430, stable rubbing treatment can be performed by winding the film around (360° or more) the rubbing roll. The transfer speed of the film is preferably 1 to 100 n/min. It is preferable that the rubbing angle appropriately falls within the range of 0 to 60°. When the film is used in a liquid crystal display device, the rubbing angle is preferably 40 to 500, and particularly preferably, 450.

The thickness of the orientation film thus obtained preferably falls within the range of 0.1 to 10 μm.

Next, the crystal liquid molecules of an optical anisotropic layer are orientationally ordered on the orientation film. Thereafter, if necessary, the orientation-film polymer is allowed to react with a multifunctional monomer contained in the optical anisotropic layer or crosslinked with the aid of a crosslinking agent.

Examples of the liquid crystal molecule for use in the optical anisotropic layer include a rod-form liquid crystal molecule and a discotic liquid crystal molecule. The rod-form liquid crystal molecule and discotic liquid crystal molecule may be high-polymer liquid crystal or low molecule liquid crystal and also include low molecule liquid crystal, which no longer exhibits the feature of liquid crystal due to crosslinking taking place therein.

[Rod-Form Liquid Crystal Molecule]

As the rod-form liquid crystal molecule, use may be preferably made of azomethines, azoxys, cyano biphenyls, cyanophenyl esters, benzoic acid esters, cyclohexanecarboxylic acid phenyl esters, cyanophenyl cyclohexanes, cyano-substituted phenyl pyrimidines, alkoxy substituted phenyl pyrimidines, phenyl dioxanes, tolanes and alkenyl cyclohexyl benzonitriles.

Note that the rod-form liquid crystal molecule includes a metal complex. A liquid crystal polymer containing a rod-form liquid crystal molecule in a repeat unit may be used as a rod-form liquid crystal molecule. In other words, the rod-form liquid crystal molecule may be bonded to a (liquid crystal) polymer.

As to the rod-form liquid crystal molecule, there is a description in Quarterly Review of Chemistry. Vol. 22, Chemistry of liquid crystal, 1994, edited by the Chemical Society of Japan (Chapters 4, 7 and 11); and liquid crystal display device handbook edited by the Japan Society for the Promotion of Science, the 142nd committee (Chapter 3).

The birefringence index of the rod-form liquid crystal molecule preferably falls within the range of 0.001 to 0.7.

The rod-form liquid crystal molecule preferably has a polymerizable group to fix the orientation state. As the polymerizable group, a radial polymerizable unsaturated group or a cationic polymerizable group is preferable. Examples of the polymerizable group include polymerizable groups and polymerizable liquid crystal compounds described in Japanese Patent Application Laid-Open No. 2002-62427 (the specification, paragraphs [0064] to [0086]).

[Discotic Liquid Crystal Molecule]

Examples of the discotic liquid crystal molecule include a benzene derivative described in a research report by C. Destrade et al. (Mol. Cryst. Vol. 71, page 111 (1981); torxene derivative described in a research report by C. Destrade et al., Mol. Cryst. Vol. 122, page 141 (1985), Physics lett, A, Vol. 78, page 82 (1990); a cyclohexane derivative described in a research report by B. Kohne et al. Angew. Chem., Vol. 96, page 70 (1984), azacrown based and phenyl acetylene based macrocycles described in research reports by M. Lehn et al. (J. Chem. Commun., page 1794 (1985) and J. Zhang et al., J. Am. Chem. Soc. Vol. 116, page 2655 (1994).

The discotic liquid crystal molecule include a liquid crystal compound having a structure in which a straight chain alkyl group, alkoxy group, and substituted benzoyl oxy group are substituted radially as side chains of a molecule center, mother nucleus. The discotic liquid crystal molecule is preferably a molecule or molecular aggregate having a rotation symmetric structure and a tendency of orientationally ordering in a certain direction. The discotic liquid crystal molecule forming the optical anisotropic layer is not necessary to keep the properties of the discotic liquid crystal molecule to the end. To explain more specifically, low-molecular weight discotic liquid crystal molecule, since it has a reactive group with heat or light, initiates a polymerization reaction or crosslinking reaction by heat or light, converting into a polymer and thus loses liquid crystal properties. Therefore, the optical anisotropic layer may contain such a low molecular-weight discotic liquid crystal molecule no longer having liquid crystallinity. Preferable examples of the discotic liquid crystal molecules are described in Japanese Patent Application Laid-Open No. 8-50206. Furthermore, the polymerization of the discotic liquid crystal molecules is described in Japanese Patent Application Laid-Open No. 8-27284.

To fix the discotic liquid crystal molecule by polymerization, it is necessary to bind a polymerizable group serving as a substituent to the discotic core of the discotic liquid crystal molecule. Compounds in which the discotic core and the polymerizable group bind via a linkage group are preferable, which allows the orientation state to be kept liquid crystal molecule compound even if a polymerization reaction takes place. Examples of the discotic liquid crystal molecules compound are described in Japanese Patent Application Laid-Open No. 2000-155216 (the specification, paragraphs [0151] to [0168]).

In hybrid orientation, the angle formed between the longitudinal axis (disk surface) of the discotic liquid crystal molecule and the surface of a polarizing film increases or decreases with an increase of the distance from the polarizing film in the depth direction of an optical anisotropic layer. The angle preferably decreases with an increase of the distance. The angle may continuously increased, continuously decreased, intermittently increased, intermittently decreased, varies (including continuous increase and continuous decrease), or intermittently varies (including an increase and decrease). The term “intermittently varies” refers to the case where the tilt angle does not change in a certain region in the middle of the thickness direction. The tilt angle may increase or decrease as a whole even though there is a region where the tilt angle does not change. Furthermore, it is preferable that the tilt angle continuously changes.

The average direction of the longitudinal axes of discotic liquid crystal molecules at the side of a polarizing film can be controlled by selecting the discotic liquid crystal molecules or a material for the orientation film or selecting a rubbing method. On the other hand, the average direction of the longitudinal axes of discotic liquid crystal molecules at the surface side (exposed to the air) can be controlled by selecting the discotic liquid crystal molecules or a type of an additive(s) used together with the discotic liquid crystal molecules. Examples of the additive(s) used together with the discotic liquid crystal molecules include a plasticizer, surfactant, polymerizable monomer and polymer. The degree of change in orientation direction along the longitudinal axis can be controlled by selecting the liquid crystal molecules and additives in the same manner as described above.

[Optical Anisotropic Layer and Other Composition]

The uniformity and strength of a coating film and the orientation of liquid crystal molecules can be improved by using additives such as a plasticizer, surfactant, polymerizable monomer together with the liquid crystal molecules. These additives is preferred to have compatibility with the liquid crystal molecules and vary the tilt angles of the liquid crystal molecules or do not inhibit the orientation of the molecules.

As the polymerizable monomer, a radical polymerizable compound or cationic polymerizable compound may be mentioned. A preferable compound is a multifunctional radical polymerizable monomer, which is copolymerizable with a liquid crystal compound containing the polymerizable group as mentioned above. Specific examples of the polymerizable monomer are described in Japanese Patent Application Laid-Open No. 2002-296423 (the specification, paragraphs [0018] to [0020]). The addition amount of the polymerizable compound generally falls within the range of 1 to 50% by weight relative to the discotic liquid crystal molecules and preferably within the range of 5 to 30% by weight.

As the surfactant, a known compound in the art may be mentioned, in particular, a fluorine compound is preferable. Specific examples of the surfactant are described in Japanese Patent Application Laid-Open No. 2001-330725 (the specification, paragraphs [0028] to [0056]).

The polymer to be used together with a discotic liquid crystal molecule preferably changes the tilt angle of the discotic liquid crystal molecule.

As an example of the polymer, a cellulose ester may be mentioned. Preferable examples of the cellulose ester are described in Japanese Patent Application Laid-Open No. 2000-155216 (the specification, paragraph [0178]). The polymer is added so as not to inhibit the orientational ordering of the liquid crystal molecules. The addition amount of the polymer preferably fall within the range of 0.1 to 10% by weight relative to the liquid crystal molecules and preferably within the range of 0.1 to 8% by weight.

The transition temperature of a discotic nematic liquid crystal phase of the discotic liquid crystal molecule to a solid phase is preferably 70 to 300° C., and further preferably 70 to 170° C.

[Formation of Optical Anisotropic Layer]

The optical anisotropic layer is formed by applying a coating solution, which contains a liquid crystal molecule and a polymerization initiator (described later) and arbitrary components as needed, onto an orientation film.

As the solvent to be used in the coating solution, an organic solvent is preferably used. Examples of the organic solvent include an amide such as N, N-dimethylformamide; sulfoxide such as dimethylsulfoxide; heterocyclic compound such as pyridine; hydrocarbon such as benzene; hexane; alkylhalide such as chloroform, dichloromethane, and tetrachloroethane; ester such as methyl acetate and butyl acetate; ketone such as acetone and methylethyl ketone; and ether such as tetrahydrofuran and 1,2-dimethoxyethane. Of them, an alkylhalide and a ketone are preferable. Two or more types of organic solvents may be used in combination.

The coating solution may be applied by a known method such as wire bar coating, extrusion coating, direct-gravure coating, reverse gravure coating, and dye-coating methods.

The thickness of the optical anisotropic layer is preferably 0.1 to 20 μm, more preferably 0.5 to 15 μm, and most preferably, 1 to 10 μm.

[Fixation of Orientation State of Liquid Crystal Molecules]

The liquid crystal molecules orientationally ordered whose orientation state can be maintained and fixed. The fixation can be performed by a polymerization reaction. Examples of the polymerization reaction include a thermal polymerization reaction using a thermal polymerization initiator and a photopolymerization reaction using a photopolymerization initiator. Of them, the photopolymerization reaction is preferable.

Examples of the photopolymerization initiator include α-carbonyl compounds (described in the specifications of U.S. Pat. Nos. 2,367,661 and 2,367,670); an acyloin ether (described in the specification of U.S. Pat. No. 2,448,828); α-hydrocarbon substituted aromatic acyloin ether (described in the specification of U.S. Pat. No. 2,722,512); multinuclear quinone compound (described in the specifications of U.S. Pat. Nos. 3,046,127 and 2,951,758); use of triallyl-imidazolyl dimer and p-aminophenyl ketone (described in the specification of U.S. Pat. No. 3,549,367); acridine and phenazine compound (described in the specifications of Japanese Patent Application Laid-Open No. 60-105667, U.S. Pat. No. 4,239,850); and oxadiazole compound (described in the specifications of U.S. Pat. No. 4,212,970).

The amount of the photopolymerization initiator to be used preferably falls within the range of 0.01 to 20% by weight relative to the solid matter of a coating solution, and more preferably within the range of 0.5 to 5% by weight.

As light irradiation for polymerizing liquid crystal molecules, ultraviolet rays are preferably used.

Irradiation energy preferably falls within the range of 20 mJ/cm² to 50 J/cm², more preferably within the range of 20 to 5000 mJ/cm², and further preferably 100 to 800 mJ/cm². To accelerate the photopolymerization reaction, light may be irradiated while heating.

A protecting layer may be provided on the optical anisotropic layer.

It is preferable that the optical compensation film and the polarizing layer may be used in combination. To explain more specifically, a coating solution for the optical compensation film is applied onto the surface of the polarizing layer to form an optical anisotropic layer. As a result, since a polymer film is not used between the polarizing film and the optical anisotropic layer, a polarizer reduced in thickness can be obtained. In such a polarizer, stress (strain×sectional area×elastic modulus) produced by dimensional change of the polarizing film is small. When the polarizer according to the present invention is attached to a large liquid crystal display device, a high definition image can be obtained without causing a light leakage problem.

Drawing is performed such that a tilt angle between the polarizing layer and the optical compensation layer becomes consistent with the angle between transmission axes of two polarizers, which are to be adhered to both sides of liquid crystal cells constituting a LCD, and the longitudinal direction or transverse direction of liquid crystal cells. The tilt angle is generally 45°. However, in transmission type, reflection type and semi-transmission type LCD devices recently developed, the tilt angle is not always 450. The drawing direction is preferably adjusted flexibly in accordance with the design of an LCD.

[Liquid Crystal Display Device]

Each of liquid crystal modes using an optical compensation film will be explained.

(TN Mode Liquid Crystal Display Device)

A TN mode liquid crystal display device is most frequently used as a color TFT liquid crystal display device and described in many documents. In the orientation state of a liquid crystal cell indicating black in the TN mode, rod-form liquid crystal molecules rise in the middle of a cell, whereas the rod-form liquid crystal molecules lie down in the cell near the substrate.

(OCB Mode Liquid Crystal Display Device)

This is a liquid crystal cell of a bent orientation mode in which rod-form liquid crystal molecules arranged in the upper portion are orientationally ordered in a reverse direction (symmetrically) to those arranged in the lower portion of a liquid crystal cell. Such a liquid crystal display device employing liquid crystal cells of a bend-orientation mode is disclosed in the specifications of U.S. Pat. Nos. 4,583,825 and 5,410,422. Since the rod-form liquid crystals molecules arranged in the upper portion are orientationally ordered symmetrically to those of the lower portion, the bend orientation mode liquid crystal cells has self-optical compensation function. For this reason, the liquid crystal mode is also called as the OCB (optically compensatory bend) mode.

In the OCB mode as well as the TN mode, the liquid crystal cell appearing black has an orientational order state where rod form liquid crystal molecules stand up in the center of the cell, whereas lie down in close proximity to the substrate.

(VA Mode Liquid Crystal Display Device)

The VA mode liquid crystal display device is characterized in that rod-form liquid crystal molecules are orientationally ordered substantially vertically when no voltage is applied. Examples of the VA mode liquid crystal cell include

(1) a VA (vertical alignment mode liquid crystal cell of narrow definition in which rod-form liquid crystal molecules are orientationally ordered substantially vertically at no voltage application time and ordered substantially horizontally at voltage application time (described in Japanese Patent Application Laid-Open No. 2-176625);

(2) an MVA (multi-domain vertical alignment) mode liquid crystal cell with an enlarged viewing angle (described in SID97, Digest of tech. Papers (abstract) 28 (1997) p. 845);

(3) a liquid crystal cell of n-ASM (Axially Symmetric Aligned Microcell) mode in which rod form liquid crystal molecules are orientationally ordered substantially vertically at no voltage application time and orientationally ordered in a twisted nematic multi-domain mode (Japanese liquid crystal symposium (abstract), p58-59 (1998)).

(4) liquid crystal cell of a SURVAIVAL mode (announced in LCD international 98).

(Ips Mode Liquid Crystal Display Device)

The IPS mode liquid crystal display device is characterized in that rod-form liquid crystal molecules are orientationally ordered substantially horizontally in plane. The orientation of the liquid crystal molecules is changed and switched by on and off of voltage application. Specific examples of the IPS mode liquid crystal display device are described in Japanese Patent Application Laid-Open Nos. 2004-365941, 2004-12731, 2004-215620, 2002-221726, 2002-55341, and 2003-195333.

[Other Liquid Crystal Display Devices]

In the same manner as above, optical compensation can be performed when ECB (Electronic Codebook) mode and STN (Supper Twisted Nematic) mode, FLC (Ferroelectric Liquid Crystal) mode, AFLC (Anti-ferroelectric Liquid Crystal) mode, and ASM (Axially Symmetric Aligned Microcell) mode are used. Furthermore, a cellulose acylate resin film according to the present invention is effective in each of transmission type, reflective type and semi-transmission type liquid crystal display devices. A cellulose acylate resin film according to the present invention is effectively used as an optical compensation sheet for a reflective type liquid crystal display device of GH (Guest-Host) type.

These cellulose derivative films mentioned above are specifically described in Technical Report No. 2001-1745, published on Mar. 15, 2001 by the Japan Institution of Invention and Innovation, pages 45 to 59).

Provision of Anti-Reflective Layer (Anti-Reflective Film)

The anti-reflective film is formed by forming a low reflective layer serving as an antifouling layer and at least one of layer (i.e., high reflective layer and medium reflective layer) having a higher reflective index than the low reflective layer on a transparent substrate.

The anti-reflective film is a multi-layered film of transparent thin films having different reflective indexes. Each of the thin films is formed by depositing an inorganic compound (metal oxides, etc.) by a chemical vapor deposition (CVD) method or physical vapor deposition (PVD) method. On the multiple layered thin film, a coating film of colloidal metal oxide particles is formed by a sol-gel method for a metal compound such as a metal alkoxide, followed by applying post treatment thereto (UV ray irradiation: Japanese. Patent Application Laid-Open No. 9-157855; and plasma treatment: Japanese Patent Application Laid-Open No. 2002-327310).

On the other hand, as an anti-reflective film having a high productivity, various types of anti-reflective films formed by stacking thin films having inorganic particles dispersed in the matrix are proposed.

An anti-reflective film formed by coating and having anti-grazing properties may be mentioned, which has minute convex and concave portions in the uppermost anti-reflecting layer.

A cellulose acylate film according to the present invention can be applied to any type of anti-reflective film, and particularly preferably, applied to an anti-reflective film formed by coating.

[Layer Structure of Coating Type Anti-Reflective Film]

The structure of the anti-reflective film is constituted of a medium refractive layer, high refractive layer and low refractive layer (outermost layer) stacked on a substrate and designed such that the refractive indexes of these layers satisfy the following relationship:

The refractive index of the high refractive index>the refractive index of the medium refractive index>the refractive index of the transparent substrate>the refractive index of the low refractive index. Furthermore, a hard-coat layer may be provided between the transparent substrate and the medium refractive layer.

Moreover, the anti-reflective film may be formed of a medium refractive hard coat layer, high refractive layer and low refractive layer.

Examples of the anti-reflective film are described in Japanese Patent Application Laid-Open Nos. 8-122504, 8-110401, 10-300902, 2002-243906 and 2000-111706. Furthermore, another function may be imparted to each of the layers. For example, a low refractive layer having antifouling properties and a high refractive index having anti-statistic properties may be mentioned (e.g., Japanese Patent Application Laid-Open Nos. 10-206603 and 2002-243906).

The haze of the anti-reflective film is preferably 5% or less, and more preferably 3% or less. The strength of the film is preferably “1H” or more based on the pensile hardness test according to JIS K5400, more preferably “2H” or more, and most preferably, “3H” or more.

[High Refractive Layer and Medium Refractive Layer]

The high refractive layer of the anti-reflective film is formed of a hardened film containing at least ultra-fine inorganic particles of 100 nm or less in average particle size and a high refractive index and a matrix binder.

The ultra-fine inorganic particles having a high refractive index are formed of an inorganic compound having a refractive index of 1.65 or more, and preferably 1.9 or more. Examples of the inorganic compound include oxides of Ti, Zn, Sb, Sn, Zr, Ce, Ta, La and In and oxide complexes containing these metal atoms.

To obtain such ultra-fine particles, the following contrivances may be made: The surface of the particles is treated by a surface treatment agent such as silane coupling agents (Japanese Patent Application Laid-Open Nos. 11-295503 and 11-153703, and 2000-9908), anionic compounds, or organic metal coupling agents (Japanese Patent Application Laid-Open No. 2001-310432); Particles are formed so as to have a core shell structure by placing high refractive particles at the center (Japanese Patent Application Laid-Open No. 2001-166104); and a specific dispersion agent is used in combination (e.g., Japanese Patent Application Laid-Open Nos. 11-153703 and 2002-2776069 and U.S. Pat. No. 6,210,858B1).

As a material for forming a matrix, a cellulose acylate and thermosetting resin known in the art may be mentioned.

Furthermore, (as a material for forming a matrix), it is preferable to use at least one type of composition selected from the group consisting of a composition containing a multifunctional compound having at least two polymerizable groups (radical polymerizable and/or cationic polymerizable groups), a composition containing an organic metal compound having a hydrolysable group and a composition containing its partial condensation product of organic metal compound (see, for example, Japanese Patent Application Laid-Open Nos. 2000-47004, 2001-315242, 2001-31871, and 2001-296401).

Furthermore, a hardened film formed of a colloidal metal oxide, which is obtained from a hydrolytic condensation product of a metal alkoxide, and a metal alkoxide composition is preferably used as the high refractive layer (for example, described in Japanese Patent Application Laid-Open No. 2001-293818).

The refractive index of the high refractive layer is generally 1.70 to 2.20. The thickness of the high refractive layer is 5 nm to 10 μm, and more preferably 10 nm to 1 μm.

The refractive index of the medium refractive layer is adjusted so as to fall between the refractive index of the lower refractive layer and that of the high refractive layer. The refractive index of the medium refractive layer is preferably 1.50 to 1.70.

[Low Refractive Layer]

The low refractive layer is formed by lamination on the high refractive layer. The refractive index of the low refractive layer is 1.20 to 1.55, and preferably 1.30 to 1.50.

The low refractive layer is preferably formed as the outermost layer having anti-scratch properties and antifouling properties. To greatly improve the anti-scratch properties, it is effective that the surface of the low refractive layer is formed smooth. To impart smoothness, a technique known in the art for introducing silicon and fluorine into a thin film may be employed.

The refractive index of a fluorine-containing compound is preferably 1.35 to 1.50, and more preferably 1.36 to 1.47. As the fluorine-containing compound, a compound containing a fluorine atom within the range of 35 and 80% by weight and containing preferably a crosslinkable or polymerizable functional group.

Examples of the fluorine-containing compound are described in Japanese Patent Application Laid-Open Nos. 9-222503 (the specification, paragraphs [0018] to [0026]), 11-38202 (the specification, paragraphs [0019] to [0030]), 2001-40284 (the specification, paragraphs [0027] to [0028]) and 2000-284102.

Silicone is a compound having a polysiloxane structure may be mentioned. Of the silicone compounds, a preferably silicone compound is a polymer having a hardenable functional group or a polymerizable function group in the polymer chain and forms a crosslinking bridge in a film. Examples of such a silicone compound include reactive silicone (e.g., Silaplane manufactured by Chisso Corporation) and polysiloxane having a silanole group at both ends (see Japanese Patent Application Laid-Open No. 11-258403).

The crosslinking or polymerization reaction of a fluorine containing compound and/or a siloxane polymer having a crosslinkable or polymerizable group is preferably performed by light irradiation or heat application, which is performed simultaneously with or after application of a coating composition containing a polymerization initiator and a sensitizer for forming the outermost layer.

As the low refractive layer, a sol-gel hardened film is preferable. The sol-gel hardened film is formed by hardening an organic metal compound such as a silane coupling agent and a silane coupling agent containing a predetermined fluorine containing hydrocarbon group in the presence of a catalyst through a condensation reaction. For example, mention may be made of silane compounds containing a polyfluoroalkyl group or its partial hydrolysis condensation products (described in Japanese Patent Application Laid-Open Nos. 58-142958, 58-147483, 58-147484, 9-157582, 11-106704), and silyl compounds containing a poly[perfluoroalkylether] group, which is a long-chain group containing fluorine (described in Japanese Patent Application Laid-Open Nos. 2000-117902, 2001-48590, and 2002-53804).

The low refractive layer may contain, other than the aforementioned additives, additives including a filler, which may be a low-refractive inorganic compound whose primary particles has an average diameter of 1 to 150 nm, such as silicon dioxide (silica) and fluorine containing particles (magnesium fluoride, calcium fluoride, and barium fluoride), and which may be organic fine particles (described in Japanese Patent Application Laid-Open No. 11-3820, the specification, paragraphs [0020] to [0038]; silane coupling agent; lubricant; and surfactant.

When the low refractive layer is formed as an outermost layer, the low refractive layer may be formed by a vapor phase method such as vacuum deposition method, sputtering method, ion plating method, and plasma CVD method. In view of cost, a coating method is preferable.

The thickness of the low refractive layer is preferably 30 to 200 nm, more preferably 50 to 150 nm, and most preferably, 60 to 120 nm.

[Hard Coat Layer]

To impart physical strength to the anti-reflective film, a hard coat layer is provided on the surface of drawn/undrawn cellulose acylate film. In particular, the hard coat layer is preferably provided between the drawn/undrawn cellulose acylate film and the high refractive layer. Alternatively, in place of providing the anti-reflective layer, the hard coat layer may preferably be directly coated on the drawn/undrawn cellulose acylate film.

The hard coat layer is preferably formed by a crosslinking reaction of a photosetting and/or thermosetting compound or a polymerization reaction. As a hardenable functional group, photo-polymerizable functional group is preferable. As an organic metal compound containing a hydrolysable functional group, an organic alkoxysilyl compound is preferable.

Examples of these compounds may include those exemplified regarding the high refractive layer.

Specific examples of the compositions for the hard coat layer, are described in Japanese Patent Application Laid-Open Nos. 2002-144913 and 2000-9908, and WO0/46617.

The high refractive layer may serve as the hard coat layer. In this case, the high refractive layer is preferably formed by minutely dispersing fine particles by use of a method described regarding high refractive layer.

The hard coat layer may serve also as an anti-glare layer (described later) by introducing particles of 0.2 to 10 μm in average size therein to impart anti-glare properties.

The thickness of the hard coat layer may be appropriately controlled depending upon the use. The thickness of the hard coat layer is preferably 0.2 to 10 μm, and more preferably 0.5 to 7 μm.

The strength of the hard coat layer is preferably “H” or more based on the pensile hardness test according to JIS K5400, more preferably “2H” or more, and most preferably “3H” or more. Also, a test piece of the hard coat layer is preferably produces a low amount of abrasion powder in the taper test according to JIS K5400.

[Forward Scattering Layer]

The front scatting layer, when applied to the liquid crystal display device, is provided to improve a viewing angle when the display is seen in various angles (up and down, right and left). The forward scattering layer may serve as the hard coat layer by dispersing fine particles having different refractive indexes in the hard coat layer.

In connection with the forward scattering layer, the forward scattering coefficient is specified in Japanese Patent Application Laid-Open No. 11-38208. A transparent resin and the range of the relative refractive index of and fine particles are specified in Japanese Patent Application Laid-Open No. 2000-199809. The haze value is defined as 40% or more in Japanese Patent Application Laid-Open No. 2002-107512.

[Other Layers]

Other than the aforementioned layers, a primer layer, antistatic layer, undercoating layer, and protecting layer may be provided.

[Coating Method]

Individual layers of the anti-reflective film may be formed by a coating method. Examples of the coating method included dip-coating method, air-knife method, curtain coating method, roller coating method, wire-bar coating method, gravure coating method, micro-gravure coating method and extrusion coating method (U.S. Pat. No. 2,681,294).

[Antiglare Function]

The anti-reflective film may have an antiglare function, which is a function of scattering incident light. The antiglare function can be produced by forming concave-convex portions on the surface of the anti-reflective film. When the anti-reflective film has an antiglare function, the haze of the anti-reflective film is preferably 3 to 30%, more preferably 5 to 20%, and most preferably, 7 to 20%.

As a method of forming concave-convex portions in the surface of the anti-reflective film, any method may be used as long as it can sufficiently maintain these concave-convex portions. Examples of such a method for forming the convex-concave portions in the film surface are:

adding fine particles to a low refractive layer (e.g., Japanese Patent Application Laid-Open No. 2000-271878);
adding a small amount (0.1 to 50% by mass) of relative large particles (particle size of 0.05 to 2 μm) in the underlying layer of a low refractive layer (that is, a high refractive layer, medium refractive layer or hard coat layer) to produce a convexoconcave underlying layer, followed by forming the low refractive layer so as to keep concave-convex portions (e.g., Japanese Patent Application Laid-Open Nos. 2000-281410, 2000-95893, 2001-100004 and 2001-281407);
transferring concave-convex portions physically onto the surface of the uppermost layer (antifouling layer) after the uppermost layer is formed (e.g., embossment is described in Japanese Patent Application Laid-Open Nos. 63-278839, 11-183710 and 2000-275401).

[Usage]

An undrawn/drawn cellulose acylate film according to the present invention is useful as optical film, in particular, protective film for a polarizer, optical compensation sheet for a liquid crystal display device (phase difference film), an optical compensation sheet of a reflective liquid crystal display device, and a substrate for a silver halide photosensitive material.

In the following the measurement methods used in the present invention will be described.

### (1) Modulus of Elasticity

Modulus of elasticity was obtained by measuring the stress in the 0.5% stretching at a stress rate of 10%/min in an atmosphere of 23° C., 70% rh. Measurement was made in the MD and TD directions and the average of the measurements was used as modulus of elasticity.

### (2) Substitution Degree of Cellulose Acylate

The substitution degrees of the acyl groups of cellulose acylate and those of the acyl groups at 6-position were obtained by the method described in Carbohydr. Res. 273 (1995) 83-91 (Tedzuka et al.) using 13C-NMR.

### (3) Residual Solvent

Samples were prepared in which 300 mg of sample film is dissolved in 30 ml of methyl acetate (sample A) and in which 300 mg of sample film was dissolved in 30 ml of dichloromethane (sample B).

Measurement was made for these samples with gas chromatography (GC) under the following conditions.

Column: DB-WAX (0.25 mmφ×30 m, film-thickness 0.25 μm)

Column temperature: 50° C.

Carrier gas: nitrogen

Analysis time: 15 minutes

Amount of sample injected: 1 μml

The amount of the solvent used was determined the following method.

For sample A, from the peaks other than that of the solvent (methyl acetate), the contents were obtained using a calibration curve, and the sum of the contents was expressed by Sa.

For sample B, from the peaks which were hidden in sample A due to the peaks of the solvent, the contents were obtained using a calibration curve, and the sum of the contents was expressed by Sb.

The sum of Sa and Sb was used as the amount of residual solvent.

### (4) Loss on Heating at 220° C.

The sample was heated from room temperature to 400° C. at a heating rate of 10° C./min in an atmosphere of nitrogen using TG-DTA 2000S manufactured by MAC Science, and the weight change of 10 mg of the sample at 220° C. was used as the loss on heating at 220° C.

### (5) Melt Viscosity

Melt viscosity was measured using viscoelasticity measuring equipment with a corn plate (e.g. modular compact rheometer: Physica MCR301 manufactured by Anton Paar) under the following conditions.

The resin was fully dried so that its moisture content is 0.1% or less, and the melt viscosity was measured at a gap of 500 μm, temperature of 220° C. and shear rate of 1 (/sec).

### (6) Re, Rth

Samples were collected at 10 points at fixed intervals across the width of the film. The samples underwent moisture conditioning at 25° C., 60% rh for 4 hours. Then, the retardations at wavelength of 590 nm were measured using KOBRA-21ADH (manufactured by Oji Scientific Instruments Co., Ltd.) at 25° C. and 60% RH while allowing light to enter the film from the direction inclined at angles of +50° to −50° in increments of 10° C. to the direction normal to the film using the slow axis in plane as a rotational axis. And the in-plane retardation (Re) and thickness-direction retardation (Rth) were calculated using the measurements.

In the following the features of the present invention will be described in further detail by examples and comparative examples. It is to be understood that various changes in the materials used, the amount, proportion and treatment of the same, the treatment procedure for the same, etc. may be made without departing from the spirit of the present invention. Accordingly, it is also to be understood that the scope of the present invention is not limited to the following examples.

### EXAMPLES

### Formation of Cellulose Acylate Film

### (1) Cellulose Acylate and Additive

A powdered cellulose acylate and a heat stabilizer, as described below, were used.

### Cellulose Acylate:

Substituents and substitution degree: acetyl group 0.23

Propionyl group 2.59

Number average molecular weight: Mn=66000

### Heat Stabilizer:

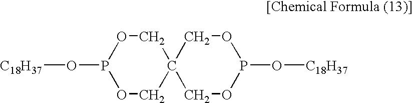

### (2) Melt Film Formation

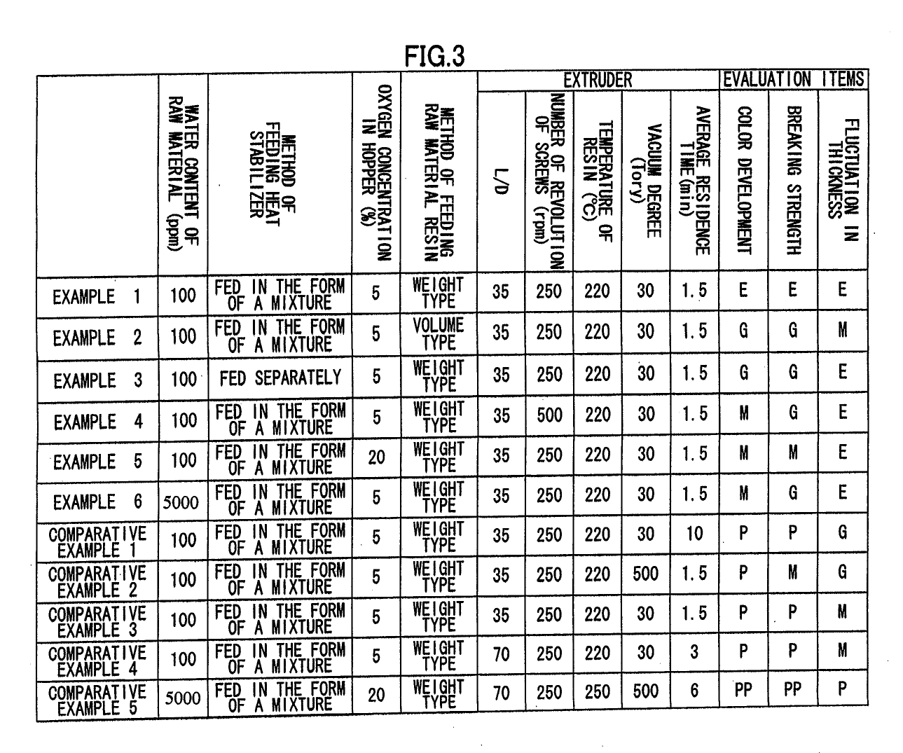

The powdered cellulose acylate resin was dried with dehumidified air having a dew-point temperature of −40° C. The water content of the cellulose acylate resin is described in a table of FIG. 3. The dried resin was put into a hopper. As extruder, a twin-screw extruder having complete-mating-type screws was used. The conditions of the extruder, L/D, the number of revolution of screws, melting temperature, vacuum degree and resin residence time, were shown in the table. The resin extruded from the extruder was weighed and delivered in a fixed amount by a gear pump. The molten resin delivered from the gear pump was filtered through a leaf disc filter with a filtration rating of 5 μm, extruded from a hanger coat die with slits spaced at intervals of 0.8 mm via a static mixer, and solidified in a casting drum. At this operation, static electricity was applied to solidified resin for its portions of 10 cm from both ends by static electricity application method for each level (a wire of 10 kV was positioned 10 cm apart from the point of the casting drum where the resin was landed). The solidified melt was stripped off from the casting drum, both ends (5% of the total width for each) of the strip underwent trimming right before wound up and knurling 10 mm wide and 50 μm high, and then 3000 m of the strip was wound up at a wind-up ratio of 30 m/min. The width of the un-stretched films thus obtained was 1.5 m irrespective of level.

### (3) Evaluation of Films (Un-Stretched) Formed by Melt Forming Method

The cellulose acylate films thus obtained were evaluated by the following methods.

### (Color Development (YI Value))

Yellowness (YI: yellowness index) was measured in accordance with JIS K7105 6.3 using Z-ii OPTICAL SENSOR.

The tristimulus values X, Y, Z of each film were determined by transmission method. And YI value was calculated from the following equation using the determined tristimulus values X, Y, Z.

YI={(1.28X−1.06Z)/Y}×100

Each film was evaluated based on its YI value in the following manner. The YI value calculated from the above equation was divided by the thickness of the film and expressed in terms of/mm. Each film was evaluated using five rankings: E, YI value in/mm was less than 10; G, YI value in/mm was 10 or more and less than 15; M, YI value in/mm was 15 or more and less than 20; P, YI value in/mm was 20 or more and less than 25; and PP, YI value in/mm was 25 or more.

### (Elongation at Breakage)

Tensile test (using Strograph, manufactured by TOYOSEIKI) was conducted for samples 10 mm wide. The breaking strength both in the transverse direction and in the flowing direction when the samples were pulled was measured. The samples were evaluated using five rankings: E, samples in which variation in strength is within ±2%; G, samples in which variation in strength is within ±5%; M, samples in which variation in strength is within ±10%; P, samples in which variation in strength is within ±20%; and PP, samples in which variation in strength is higher than ±20%.

### (Measurement of Fluctuation in Thickness)

Fluctuation in thickness was measured for each sample using electron micrometer manufactured by Anritsu at a speed of 600 mm/min, recorded on chart paper on a scale of 1/20 and at a chart speed of 30 mm/min, and measured with a ruler. Evaluation was made using five rankings: E, samples in which fluctuation in thickness is within ±2%; G, samples in which fluctuation in thickness is within ±5%; M, samples in which fluctuation in thickness is within ±10%; P, samples in which fluctuation in thickness is within ±20%; and PP, samples in which fluctuation in thickness is wider than ±20%.

As is apparent from the table of FIG. 3, in preparation of the cellulose acylate films of Comparative examples 1 to 5, any of the following conditions: the L/D was in the range of 20 to 55, the temperature of molten resin was in the range of Tm+10° C. to Tm+70° C., the average residence time was within 5 minutes, and a vacuum was drawn so that the vacuum degree was 100 Torr or lower midway along extruder were not satisfied; as a result, the rankings of the resultant films for color change, breaking strength, fluctuation in thickness were low. Contrary, in the preparation of the cellulose acylate films of Examples 1 to 6, all the following conditions: the L/D in the range of 20 to 55, the temperature of molten resin in the range of Tm+10° C. to Tm+70° C., the average residence time within 5 minutes, and drawing a vacuum so that the vacuum degree is 100 Torr or lower midway along extruder were satisfied. Particularly in the preparation of the film of Example 1, the conditions: the oxygen concentration in hopper was 10% or lower, which was not satisfied in the preparation in Example 5; the number of revolution of the screw was 50 to 300 rpm, which was not satisfied in the preparation in Example 4; a heat stabilizer was added to the resin before the resin was fed into extruder, which was not satisfied in the preparation in Example 3; and the resin was fed into extruder constant-weight feeder, which was not satisfied in the preparation in Example 2, were all satisfied. Thus, the film of Example 1 gained most significant ranking all for the color development, breaking strength and fluctuation in thickness.

### (4) Preparation of Polarizer

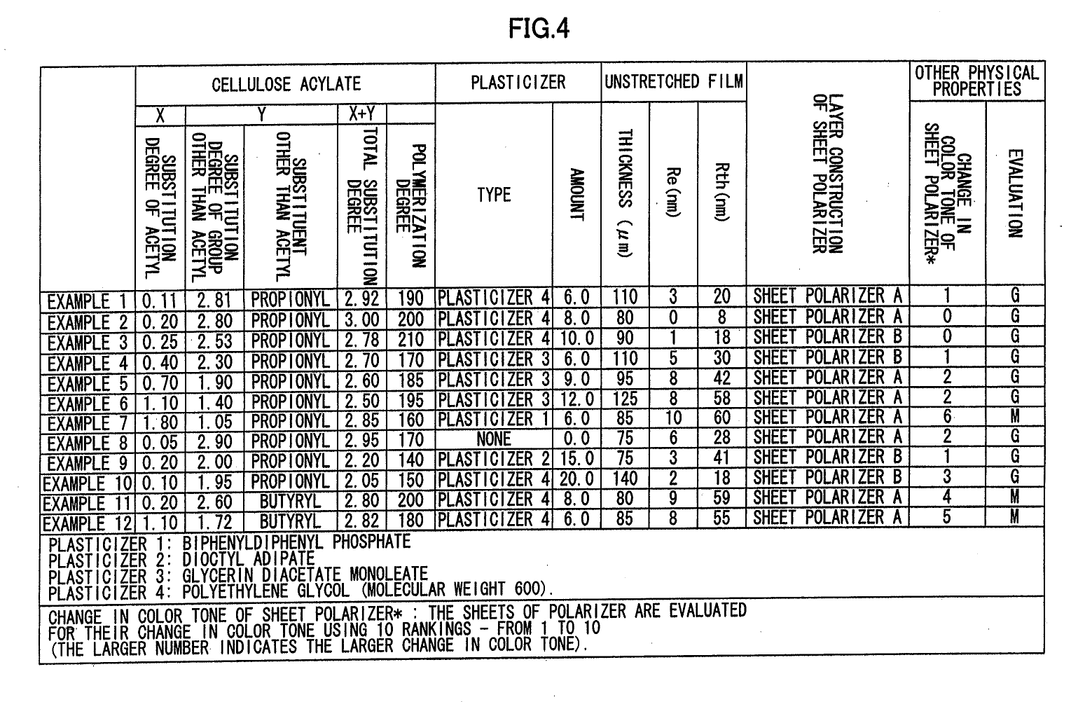

Polarizers below were prepared using non-stretched films which had been formed under the film forming conditions of Example 1 (probably the best mode) shown in the table of FIG. 3 using different film materials (different in substitution degree, degree of polymerization and plasticizer) as shown in a table of FIG. 4.

(4-1) Saponification of Cellulose Acylate Film

An undrawn cellulose acylate film is saponificated by soaking as described bellows. For the film saponificated by coating, the same results was obtained.

(i) Saponification by Coating

20 parts by weight of water is added to 80 parts by weight of iso-propanol. To this mixture, KOH is dissolved up to a concentration of 2.5 N. The resultant mixture controlled in temperature at 60° C. was used as a saponification solution.

This saponification solution was applied onto a cellulose acylate film in a ratio of 10 g/m² to saponificate the film for one minute. Thereafter, warm water of 50° C. was sprayed onto the film at a rate of 10 L/m²/minute to wash it.

(ii) Saponification by Soaking

A 2.5N aqueous NaOH solution was used as a saponification solution.

A cellulose acylate film was soaked in the solution controlled at 60° C. for 2 minutes.

Thereafter, it was soaked in a 0.1N aqueous sulfuric acid solution for 30 seconds and transferred to a water bath.

(4-2) Preparation of Polarizing Layer

Accordance to Example 1 of Japanese Patent Laid-Open No. 2001-141926, a film was drawn in the longitudinal direction by rotating two pairs of nip rolls at different rotation speeds (peripheral speed) to prepare a polarizing layer of 20 μm in thickness.

(4-3) Adhesion

The polarizing layer thus prepared, the above described saponified unstretched and stretched cellulose acylate films, and saponified Fujitack (unstretched triacetate film) were adhered with a 3% PVA aqueous solution (PVA-117H, manufactured by Kuraray Co., Ltd.) as an adhesive agent, in the direction of the polarizing film stretching and the cellulose acylate film forming flow (longitudinal direction) in the following combinations.

Polarizer A: unstretched cellulose acylate film/polarizing layer/Fujitack
Polarizer B: unstretched cellulose acylate film/polarizing layer/unstretched cellulose acylate film

(4-4) Color Tone Change of Polarizer

The magnitude of the color tone change of the polarizers thus obtained was evaluated using 10 rankings (the larger number indicates the larger color tone change). The sheets of polarizer prepared by embodying the present invention gained high rankings.

(4-5) Evaluation of Humidity Curl

The polarizers thus obtained were evaluated by the above described method. The cellulose acylate film formed into polarizers by embodying the present invention showed good characteristics (low humidity curl).

Polarizers were also prepared in which lamination was performed so that the polarization axis and the longitudinal direction of the cellulose acylate film were crossed at right angles and at an angle of 45°. The same evaluation was made for them. The results were the same as the sheets of polarizer in which the polarizing film and the cellulose acylate film were laminated in parallel with each other.

### (5) Preparation of Optical Compensation Film and Liquid Crystal Display Device

The polarizer provided on the observers' side in a 22-inch LCD (manufactured by Sharp Corporation) in which VA-mode LC cell was used was stripped off. Instead of the polarizer, the above described retardation polarizer A or B was laminated on the observers' side in the above LCD via an adhesive so that the cellulose acylate film faced the LC cells. A liquid crystal display was prepared by arranging the polarizer so that the transmission axis of the polarizer on the observers' side and that of the polarizer on the backlight side were crossed at right angles.

In this case, too, the cellulose acylate film of the present invention exhibit a low humidity curl, and therefore, it was easy to laminate, whereby it was less likely to be out of position when laminated.

Further, when using the cellulose acylate film of the present invention, instead of the cellulose acetate film of Example 1 described in Japanese Patent Laid-Open No. 11-316378 whose surface was coated with a liquid crystal layer, a good optical compensation film, which exhibited a low humidity curl, could be obtained.

When using the cellulose acylate film of the present invention, instead of the cellulose acetate film of Example 1 described in Japanese Patent Laid-Open No. 7-333433 whose surface was coated with a liquid crystal layer, a good optical compensation film, which exhibited a low humidity curl, could be obtained.

Further, when using the polarizer and retardation polarizer of the present invention in the liquid crystal display described in Example 1 of Japanese Patent Laid-Open No. 10-48420, for the optically anisotropic layer containing discotic liquid crystal molecules, for the oriented film whose surface was coated with polyvinyl alcohol, in the 20-inch VA-mode liquid crystal display described in FIGS. 2 to 9 of Japanese Patent Laid-Open No. 2000-154261, in the 20-inch OCB-mode liquid crystal display described in FIGS. 10 to 15 of Japanese Patent Laid-Open No. 2000-154261, and in the IPS-mode liquid crystal display described in FIG. 11 of Japanese Patent Laid-Open No. 2004-12731, good liquid crystal display devices, which exhibited a low humidity curl, were obtained.

### (6) Preparation of Low Reflection Film

A low reflection film was prepared using the cellulose acylate film according to the present invention in accordance with Example 47 described in Journal of Technical Disclosure (Laid-Open No. 2001-1745) issued by Japan Institute of Invention and Innovation. The humidity curl of the prepared film was measured by the above described method. The cellulose acylate film formed by embodying the present invention produced good results when formed into a low reflection film, just like the case where it is formed into sheets of polarizer.

The low reflection film of the present invention was laminated on the outermost surface of the liquid crystal display described in Example 1 of Japanese Patent Laid-Open No. 10-48420, the 20-inch VA-mode liquid crystal display described in FIGS. 2 to 9 of Japanese Patent Laid-Open No. 2000-154261, the 20-inch OCB-mode liquid crystal display described in FIGS. 10 to 15 of Japanese Patent Laid-Open No. 2000-154261, and the IPS-mode liquid crystal display described in FIG. 11 of Japanese Patent Laid-Open No. 2004-12731 and the resultant liquid crystal displays were evaluated. The liquid crystal display devices obtained were all good.

1. A method for manufacturing a cellulose acylate film using a powdered cellulose acylate resin as a resin to be melted in an extruder, the method comprising
melting the cellulose acylate resin fed from a hopper in the extruder;
discharging the molten resin from the extruder to feed the same into a die;
extruding the molten resin from the die in the form of sheet; and
cooling and solidifying the molten resin in the form of sheet,
wherein a twin-screw extruder which has complete-mating-type screws and whose L/D is set in the range of 20 to 55 is used while setting the melting temperature for melting the resin to be melted in the range of Tm+10° C. to Tm+70° C., where Tm represents the melting point of the cellulose acylate resin, keeping the average residence time of the cellulose acylate resin, the time from feeding the resin into the extruder to discharging the same from the extruder, within 5 minutes, and drawing a vacuum on the inside of the extruder so that the degree of vacuum in the extruder after the powdered cellulose acylate resin has been melted is kept at 100 Torr or lower.

2. The method for manufacturing a cellulose acylate film according to claim 1, wherein the powdered cellulose acylate resin is melted in the extruder after its moisture content is adjusted to 5000 ppm or lower.

3. The method for manufacturing a cellulose acylate film according to claim 1, wherein the oxygen concentration in the hopper is 10% or lower.

4. The method for manufacturing a cellulose acylate film according to claim 1, wherein the number of revolution of the screws of the extruder is set in the range of 50 to 300 rpm.

5. The method for manufacturing a cellulose acylate film according to claim 1, wherein the cellulose acylate resin is mixed before melting with a heat stabilizer and then fed into the extruder.

6. The method for manufacturing a cellulose acylate film according to claim 1, wherein the powdered cellulose acylate resin is fed into the extruder by a constant-weight feeder.

7. A cellulose acylate film, manufactured by the manufacturing method according to claim 1.

8. The method for manufacturing a cellulose acylate film according to claim 2, wherein the oxygen concentration in the hopper is 10% or lower.

9. The method for manufacturing a cellulose acylate film according to claim 2, wherein the number of revolution of the screws in the extruder is set in the range of 50 to 300 rpm.

10. The method for manufacturing a cellulose acylate film according to claim 2, wherein the cellulose acylate resin is mixed before melting with a heat stabilizer and then fed into the extruder.

11. The method for manufacturing a cellulose acylate film according to claim 2, wherein the powdered cellulose acylate resin is fed into the extruder by a constant-weight feeder.

12. A cellulose acylate film, manufactured by the manufacturing method according to claim 2.

13. The method for manufacturing a cellulose acylate film according to claim 3, wherein the number of revolution of the screws of the extruder is set in the range of 50 to 300 rpm.

14. The method for manufacturing a cellulose acylate film according to claim 3, wherein the cellulose acylate resin is mixed before melting with a heat stabilizer and then fed into the extruder.

15. The method for manufacturing a cellulose acylate film according to claim 3, wherein the powdered cellulose acylate resin is fed into the extruder by a constant-weight feeder.

16. A cellulose acylate film, manufactured by the manufacturing method according to claim 3.

17. The method for manufacturing a cellulose acylate film according to claim 4, wherein the cellulose acylate resin is mixed before melting with a heat stabilizer and then fed into the extruder.

18. The method for manufacturing a cellulose acylate film according to claim 4, wherein the powdered cellulose acylate resin is fed into the extruder by a constant-weight feeder.

19. A cellulose acylate film, manufactured by the manufacturing method according to claim 4.
